(19) United States
(12) Patent Application Publication
(10) Pub. No.: US 2025/0369774 A1
(43) Pub. Date: Dec. 4, 2025

(54) WEARABLE ELECTRONIC DEVICE AND METHOD FOR OPERATING THEREOF

(71) Applicant: SAMSUNG ELECTRONICS CO., LTD., Suwon-si (KR)

(72) Inventors: Jinwook CHOI, Suwon-si (KR); Sunglak KIM, Suwon-si (KR); Jihoon KIM, Suwon-si (KR); Jooyeol RYU, Suwon-si (KR); Yeonggyu YOON, Suwon-si (KR); Sunyong CHOI, Suwon-si (KR); Jungwoo LEE, Suwon-si (KR)

(73) Assignee: SAMSUNG ELECTRONICS CO., LTD., Suwon-si (KR)

(21) Appl. No.: 19/280,460

(22) Filed: Jul. 25, 2025

Related U.S. Application Data
(63) Continuation of application No. PCT/KR2025/007335, filed on May 29, 2025.

(30) Foreign Application Priority Data
May 29, 2024 (KR) 10-2024-0070412
Jun. 10, 2024 (KR) 10-2024-0075206

(51) Int. Cl. G01D 5/14; G06F 3/0362

(52) U.S. Cl. CPC G01D 5/142; G06F 3/0362

(57) ABSTRACT

Provided is an electronic device including a first housing having a ring shape, a second housing having a ring shape, the first housing and the second housing being connected and rotatable relative to each other, a plurality of magnet members, at least some of the plurality of magnet members being at different intervals in the second housing, a sensor in the first housing and configured to detect a magnetic force generated from the plurality of magnet members, a memory configured to store instructions, and at least one processor configured to execute the instructions to control the sensor to detect a change in the magnetic force that is generated from the plurality of magnet members based on the second housing rotating relative to the first housing, and detect a rotation attribute of the second housing relative to the first housing based on an attribute of the detected change in the magnetic force.

### CROSS-REFERENCE TO RELATED APPLICATIONS

This application is a bypass continuation of International Application No. PCT/KR2025/007335, filed on May 29, 2025, which is based on and claims priority to Korean Patent Application No. 10-2024-0070412, filed on May 29, 2024 and Korean Patent Application No. 10-2024-0075206, filed on Jun. 10, 2024 in the Korean Intellectual Property Office, the disclosures of which are incorporated by reference herein in their entireties.

### BACKGROUND

Embodiments of the present disclosure relate to a wearable electronic device and an operation method thereof.

As the functions of mobile electronic devices are increasingly diversified, mobile electronic devices are implemented in the form of multimedia devices, and structural and software parts of the devices are enhanced. In particular, as portable electronic devices are miniaturized and portability is improved, wearable devices may be provided. Recently, wearable electronic devices such as smart rings, smart bracelets among various mobile electronic devices are increasingly used. Smart rings may be worn on a user's fingers.

With the recent rapid development of internet of things (IoT) technology in households, there is a need for methods for more effectively managing various devices in households. Accordingly, wearable devices and wearable device interfaces that may be easily manipulated while being worn by users are being developed.

The above-described information is provided as a related-art technology for the purpose of assisting in understanding the disclosure. Any assertion or decision is not presented as to what content of the above-described contents is applied as prior art related to the disclosure.

### SUMMARY

According to an aspect of one or more embodiments, there is provided an electronic device including a first housing having a ring shape, a second housing having a ring shape, the first housing and the second housing being connected and rotatable relative to each other, a plurality of magnet members, at least some of the plurality of magnet members being at different intervals in the second housing, a sensor in the first housing and configured to detect a magnetic force generated from the plurality of magnet members, a memory configured to store instructions, and at least one processor configured to execute the instructions to control the sensor to detect a change in the magnetic force that is generated from the plurality of magnet members based on the second housing rotating relative to the first housing, and detect a rotation attribute of the second housing relative to the first housing based on an attribute of the detected change in the magnetic force.

The rotation attribute may include at least one of a speed at which the second housing rotates relative to the first housing, a direction in which the second housing rotates relative to the first housing, and a position of the sensor relative to the first housing.

According to another aspect of one or more embodiments, there is provided an electronic device including a first housing having a ring shape, a second housing having a ring shape, the first housing and the second housing being connected and rotatable relative to each other, a plurality of magnet members including a first magnet member and a second magnet member, a portion of the first magnet member that has a first magnetic property and a portion of the second magnet member that has a second magnetic property being in the second housing adjacent to the first housing, a sensor in the first housing and configured to detect a magnetic force generated from the plurality of magnet members, a memory configured to store instructions, and at least one processor configured to execute the instructions to control the sensor to detect a change in the magnetic force generated from the plurality of magnet members based on the second housing rotating relative to the first housing, and detect a rotation attribute of the second housing relative to the first housing based on an attribute of the detected change in the magnetic force, wherein the first magnetic property and the second magnet property are different from each other.

A polarity of the first magnetic property may be opposite to a polarity of the second magnetic property.

A magnitude of the first magnetic property may be different from a magnitude of the second magnetic property.

The plurality of magnet members may include a plurality of magnet member sets, and a first magnet member set of the plurality of magnet member sets may include the first magnet member and the second magnet member.

The plurality of magnet member sets may include the first magnet member set and a second magnet member set, and a gap between the first magnet member and the second magnet member in the first magnet member set may be less than a gap between the first magnet member set and the second magnet member set.

The plurality of magnet members may further include a third magnet member having a third magnetic property, and a magnitude of a magnetic property of the first magnet member may be greater than a magnitude of a magnetic property of the second magnet member, the magnitude of the magnetic property of the second magnet member may be greater than a magnitude of a magnetic property of third magnet member.

Gaps between adjacent magnet members of the plurality of magnet members may be different.

Gaps between adjacent magnet members of the plurality of magnet members may gradually increase.

The at least one processor may be further configured to execute the instructions to transmit a signal corresponding to the identified rotation attribute to a first external electronic device.

The first external electronic device may be configured to detect a second external electronic device to be controlled by the electronic device based on the signal corresponding to the identified rotation attribute.

The second external electronic device may be in a direction that a rotation axis of the first housing or a rotation axis of the second housing faces.

According to still another aspect of one or more embodiments, there is provided a method for detecting a rotation attribute of a housing by an electronic device, the method including controlling a sensor in a first housing to detect a change in a magnetic force generated from a plurality of magnet members based on the second housing rotating relative to the first housing, and detecting a rotation attribute of the second housing relative to the first housing based on an attribute of the detected change in the magnetic force, wherein at least some of the plurality of magnet members are in the second housing at different intervals.

The rotation attribute may include at least one of a speed at which the second housing rotates relative to the first housing, a direction in which the second housing rotates relative to the first housing, and a position of the sensor relative to the first housing that is displaced based on the rotation.

According to still another aspect of one or more embodiments, there is provided a method for detecting a rotation attribute of a housing by an electronic device, the method including controlling a sensor in a first housing to detect a change in a magnetic force generated from a plurality of magnet members based on the second housing rotating relative to the first housing, and detecting a rotation attribute of the second housing relative to the first housing based on an attribute of the detected change in the magnetic force, wherein the plurality of magnet members include a first magnet member and a second magnet member, and wherein a portion of the first magnet member that has a first magnetic property and a portion of the second magnet member that has a second magnetic property are in the second housing and adjacent to the first housing.

A polarity of the first magnetic property may be opposite to a polarity of the second magnetic property.

A magnitude of the first magnetic property may be different from a magnitude of the second magnetic property.

The method may further include transmitting a signal corresponding to the identified rotation attribute to a first external electronic device, and detecting, by the first external electronic device, a second external electronic device to be controlled by the electronic device based on the signal corresponding to the identified rotation attribute.

The second external electronic device may be in a direction that a rotation axis of the first housing or a rotation axis of the second housing faces.

### BRIEF DESCRIPTION OF DRAWINGS

Embodiments will be more clearly understood from the following detailed description taken in conjunction with the accompanying drawings in which:

FIG. 1 is a perspective view and a cross-sectional view illustrating a structure of an electronic device according to one or more embodiments;

FIG. 2 is a perspective view of the electronic device according to one or more embodiments and a cross-sectional view illustrating inner components of the electronic device;

FIG. 3 is a cross-sectional view illustrating arrangements of some components of the electronic device and movements of the electronic device according to one or more embodiments;

FIGS. 4A and 4B illustrate a method by which magnet members are arranged in the electronic device, and a method of identifying a rotation attribute of a housing through a change attribute in a magnetic force by rotation of the housing according to one or more embodiments;

FIGS. 5A and 5B illustrate a method by which magnet members are arranged in the electronic device, and a method of identifying ae rotation attribute of the housing through a change attribute in a magnetic force according to one or more embodiments;

FIGS. 6A and 6B illustrate an example of arrangements of magnet members in the electronic device, and a method of identifying a rotation attribute of the housing through a change attribute of a magnetic force according to one or more embodiments;

FIGS. 7A, 7B, and 7C illustrate an example of arrangements of magnet members in the electronic device, and an example of identifying a rotation attribute of the housing through a change attribute in a magnetic force according to one or more embodiments;

FIGS. 8A and 8B illustrate an example of arrangements of magnet members in the electronic device, and an example of identifying a rotation attribute of the housing through a change attribute in a magnetic force according to one or more embodiments;

FIGS. 9A and 9B illustrate an example of arrangements of magnet members at different intervals in the electronic device, and a change attribute in a magnetic force according to one or more embodiments;

FIGS. 10A and 10B illustrate arrangements of magnet members having different magnetic properties in the electronic device, and a change attribute in a magnetic force according to one or more embodiments;

FIGS. 11A and 11B illustrate a change attribute in a magnetic force by a rotation speed of the housing in the electronic device according to one or more embodiments;

FIG. 12 is a flowchart of a process of identifying a rotation attribute of a second housing relative to a first housing in the electronic device according to one or more embodiments;

FIG. 13 illustrates the electronic device and peripheral devices of the electronic device according to one or more embodiments;

FIG. 14 is a flowchart illustrating a process in which a second external electronic device performs an operation corresponding to an identified rotation attribute according to the identified rotation attribute of the electronic device in the electronic device according to one or more embodiments;

FIG. 15 is a flowchart of a process in which the electronic device communicates with a second external electronic device by a first external electronic device according to one or more embodiments;

FIGS. 16A, 16B, and 16C illustrate a method by which the electronic device identifies positions of external electronic devices via an antenna according to one or more embodiments;

FIG. 17 illustrates a connection structure between the electronic device and external electronic devices, and a position identification method according to one or more embodiments;

FIG. 18 illustrates a method of identifying positions of the electronic device and the external electronic devices according to one or more embodiments;

FIGS. 19A and 19B illustrate a range in which the electronic device identifies whether an external electronic device is positioned in a direction that a rotation surface of a housing faces according to one or more embodiments;

FIG. 20 illustrates an example of controlling an external electronic device which is positioned in the direction that the rotation surface of the housing of the electronic device faces according to one or more embodiments; and

FIG. 21 is a block diagram of an electronic device in a network environment according to one or more embodiments.

Regarding explanation of the drawings, the same or like reference numerals may be used to refer to the same or like components.

### DETAILED DESCRIPTION

Hereinafter, one or more embodiments of the disclosure will be described in detail with reference to the accompanying drawings so that a person skilled in the art can easily embody. However, the disclosure may be implemented in different forms and is not limited to the embodiments set forth herein. In addition, in the drawings, parts having nothing to do with the descriptions are omitted for the clear description of the disclosure, and throughout the specification, the same or like reference numerals are used for the same or like elements.

The terms used in the disclosure are described as general terms currently used considering the functions mentioned in the disclosure, but may refer to various other terms according to the intent of those skilled in the art, precedent, the emergence of new technologies. Accordingly, the terms used in the disclosure should not be interpreted solely based on their names and should be interpreted based on the meaning of the terms and the whole context of the disclosure.

In addition, such terms as “1st” and “2nd,” or “first” and “second” may be used to explain various components, but the components should not be limited by such terms. These terms may be used for the purpose of distinguishing one component from other components.

Throughout the specification, it is to be understood that if an element is referred to as “connected with/to” another element, it means that the element may be “directly connected” with another element or may be “electrically connected” or “operatively connected” with another element via an intervening element therebetween. It will be further understood that when a certain portion is referred to as “including” a certain element, it means that the certain portion does not exclude other components and may further include other components unless the context clearly indicates otherwise.

The phrase “in one or more embodiments” used in the disclosure does not necessarily indicate the same embodiment.

One or more embodiments of the disclosure may be represented by functional block configurations and various processing steps. Some or all of the functional blocks may be implemented by various numbers of hardware and/or software configurations that perform specific functions. For example, the functional blocks of the disclosure may be implemented by one or more microprocessors or may be implemented by circuit configurations for predetermined functions. In addition, for example, the functional blocks of the disclosure may be implemented by various programming or scripting languages. The functional blocks may be implemented by an algorithm that is executed in one or more processors. The disclosure may employ related-art technologies for electronic configuration, signal processing, and/or data processing. Such terms “mechanism”, “element”, “means”, and “configuration” may be broadly used and are not limited to mechanical and physical configurations.

In addition, connecting lines or connecting members among components shown in the drawings are only examples of functional connection and/or physical or circuitry connections. In an actual device, connections among components may be represented by a variety of alternative or additional functional connection, physical connection, or circuit connections.

An electronic device according to one or more embodiments of the disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. However, this should not be considered as limiting.

In one or more embodiments, the electronic device may be a home appliance. The home appliance may include at least one of, for example, televisions (TVs), digital video disk (DVD) players, audios, refrigerators, air conditioners, cleaners, ovens, microwave ovens, washing machines, air cleaners, set-top boxes, home automation control panels, security control panels, TV boxes, game consoles, electronic dictionaries, electronic keys, camcorders, or electronic picture frames. However, this should not be considered as limiting.

According to one or more embodiments, the electronic device may include at least one of medical devices (for example, various portable medical measurement devices (for example, a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, global navigation satellite systems (GNSS), event data recorders (EDRs), flight data recorders (FDRs), vehicle infotainment devices, electronic equipment for vessels (for example, navigation systems and gyrocompasses), avionics, security devices, head units for vehicles, industrial or home robots, automatic teller's machines (ATMs) of financial institutions, points of sales (POSs) of stores, or Internet of things (for example, light bulbs, various sensors, electricity or gas meters, sprinkler devices, fire alarms, thermostats, street lamps, toasters, exercise equipment, hot water tanks, heaters, boilers, or the like).

According to one or more embodiments, the electronic device may include at least one of furniture, a part of buildings/structures, electronic boards, electronic signature receiving devices, projectors, or various measuring instruments (for example, water meters, electricity meters, gas meters, or wave meters). In one or more embodiments, the electronic device may be one or a combination of two or more devices of the above-mentioned devices. According to one or more embodiments, the electronic device may be a flexible electronic device. Also, the electronic device according to one or more embodiments of the disclosure is not limited to the above-mentioned devices, and may include new electronic devices according to technology development.

According to one or more embodiments, the electronic device may be a wearable device. According to one or more embodiments, the wearable device may include at least one of accessories (for example, watches, rings, bracelets, ankle bracelets, necklaces, glasses, contact lenses, head-mounted-devices (HMDs), etc.), fabric- or clothing-mounted devices (for example, electronic apparels), body-mounted devices (for example, skin pads, tattoos, etc.), or bio-implantable devices (for example, implantable circuits). However, this should not be considered as limiting.

An electronic device according to the disclosure may include a plurality of rotatable housings. According to the disclosure, when the plurality of housings rotate relative to at least one other housing, the electronic device may effectively detect a rotation attribute of the plurality of housings with a smaller number of hall sensors. The disclosure may provide an electronic device which includes a plurality of magnet members having different magnetic properties to exactly identify (detect) rotation of housings and a rotation attribute thereof at a relatively low cost. The disclosure may provide an electronic device which has a plurality of magnet members arranged at different intervals to exactly identify (detect) rotation of housings and a rotation attribute thereof at a relatively low cost.

The disclosure may provide an electronic device including a plurality of housings that, when at least one housing rotates relative to at least one other housing, may control an external electronic device positioned in a direction that a surface corresponding to the direction of rotation faces (for example, a direction that a rotation axis faces). Accordingly, a wearable interface that a user may control more intuitively and easily may be implemented, and a convenient in-home IoT environment may be provided.

In the disclosure, magnet members having different magnetic properties may include magnetic members having different magnetic forces acting on a hall sensor. For example, magnet members having different magnetic properties may include magnet members having different polarities of magnetic forces acting on a hall sensor. For example, magnetic members having different magnetic properties may include magnet members having different magnitudes of magnetic forces acting on a hall sensor.

Hereinafter, the disclosure will be described in detail with reference to the accompanying drawings.

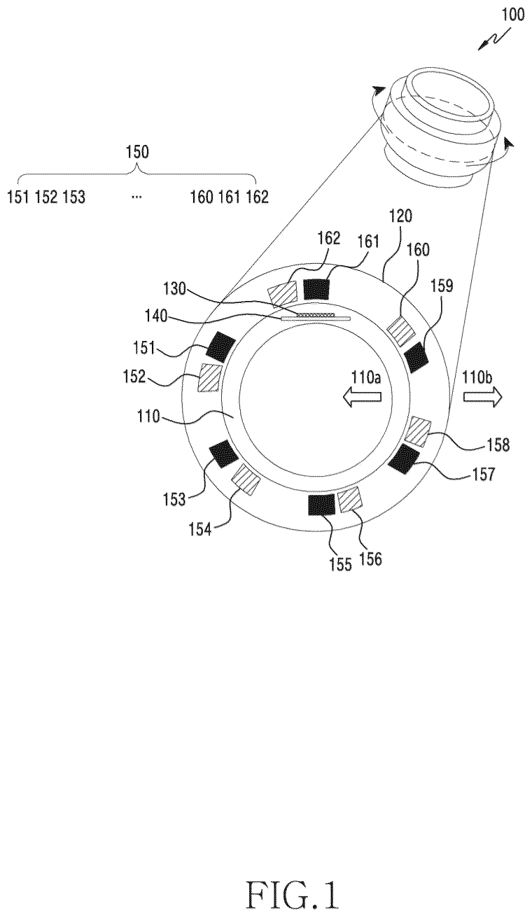

FIG. 1 is a perspective view and a cross-sectional view illustrating a structure of an electronic device according to one or more embodiments of the disclosure.

Referring to FIG. 1, the electronic device 100 according to one or more embodiments may include at least one of a smart ring or a smart bracelet. However, embodiments are not limited thereto. For example, the electronic device 100 may include various electronic devices which are worn by a user's body or are in contact with the user's body. For example, the electronic device 100 may include various electronic devices in which one housing moves along another housing.

The electronic device 100 according to one or more embodiments may have a ring shape. In an example, the electronic device 100 may have at least one shape of a cylindrical shape, a donut shape, or a loop shape. However, embodiments are not limited thereto. For example, the electronic device 100 may have various shapes to be worn on user's body or to be in contact with user's body. For example, the electronic device 100 may have at least one of a shape having a curvature at least in part or a bar shape.

According to one or more embodiments, the electronic device 100 may include an inner side (an inner surface, an inside surface or an inner circumference) that faces a direction facing a body (for example, a user's finger) of the user wearing the electronic device 100, and an outer side (outer surface, an outside surface, or an outer circumference) that faces the opposite direction of the direction facing the body (for example, a user's finger) of the user wearing the electronic device 100. For example, the outer side of the electronic device may be formed of a material that is resistant to a shock or scratches. For example, the outer side of the electronic device may be coated with a predetermined material. For example, the inner side of the electronic device may be formed of the same material as the material forming the outer side of the electronic device. For example, the inner side of the electronic device may include a molding material, transparent plastic, glass, etc. to detect a predetermined item via a sensor. For example, the inner side of the electronic device may include a metallic material to acquire biometric data via a sensor.

According to one or more embodiments, the electronic device 100 may include housings 110, 120 (for example, a first housing 110 and a second housing 120), a plurality of magnet members 150 disposed in the housings 110, 120, a hall sensor 130 disposed in the housings 110, 120, and a printed circuit board 140 disposed in the housings 110, 120. However, the configuration of the electronic device 100 is not limited thereto. For example, the electronic device 100 may omit at least one component from the above-described components or may further include at least one component. For example, the electronic device 100 may further include a molding member that forms at least a part of the exterior of the electronic device 100.

According to one or more embodiments, the housings 110, 120 may have a curvature. For example, the housings 110, 120 may have a ring shape. In an example, the housings 110, 120 may have at least one shape of a cylindrical shape, a donut shape or a loop shape. However, embodiments are not limited thereto. For example, the housings 110, 120 may not have a curvature. For example, the housings 110, 120 may have a bar shape.

According to one or more embodiments, the housings 110, 120 may include an outer side 110b and an inner side 110a. The outer side 110b of the housings 110, 120 may face the outside of the electronic device 100 (for example, opposite radial direction facing away from the rotation axis of the housings 110, 120). The inner side 110a of the housings 110, 120 may face the inside of the electronic device 100 (for example, a radial direction facing the rotation axis). According to one or more embodiments, the housings 110, 120 may form at least a part of the exterior of the electronic device 100. For example, the housing 110 may form the outer side of the electronic device 100. The outer side 110b of the housings 110, 120 may form the outer side of the electronic device 100. According to one or more embodiments, at least a part of the housings 110, 120 may be seen from the outside of the electronic device 100. For example, the outer side 110b of the housing 110, 120 may be seen from the outside of the electronic device 100.

According to one or more embodiments, the electronic device 100 may have a rotatable shape. In one or more embodiments, the electronic device 100 may include a plurality of housings 110, 120. In one or more embodiments, the electronic device 100 may include a plurality of housings 110, 120 which are coupled (connected) to be rotatable relative to at least one other housing. For example, the electronic device 100 may include two housings 110, 120 which are coupled (connected) to be rotatable relative to at least one other housing. For example, the electronic device 100 may include two housings 110, 120 which are coupled (connected) to be rotatable about the same rotation axis relative to at least one other housing. For example, the electronic device 100 may include two ring-shaped housings 110, 120 which are coupled (connected) to be rotatable about the same rotation axis relative to at least one other housing.

According to one or more embodiments, the electronic device 100 may be worn on a user's body. For example, the electronic device 100 may be worn on user's finger, arm, wrist, neck or user's ankle. The electronic device 100 may be in contact with a user's body. For example, the electronic device 100 may be in contact with at least one of user's finger or user's arm. In an example, the electronic device 100 may be worn on a single finger of a user or may be worn across a plurality of fingers of a user.

According to one or more embodiments, the electronic device may include ring-shaped housings 110, 120. The electronic device according to one or more embodiments may be worn on a user by the ring-shaped housings 110, 120. According to one or more embodiments, the electronic device may include a plurality of ring-shaped housings 110, 120, and may be worn on a user by the plurality of ring-shaped housings 110, 120. The plurality of ring-shaped housings 110, 120 may be coupled (connected) to be rotatable relative to at least one other housing. In this case, the plurality of ring-shaped housings 110, 120 may be rotated relative to at least one other housing by the user.

According to one or more embodiments, the electronic device 100 may include at least one hole penetrating through the electronic device 100. The at least one hole may be formed by the ring-shaped housings 110, 120. For example, referring to FIG. 1, the electronic device 100 may include at least one hole. For example, a body part such as user's finger, wrist, arm, ankle, etc. may be inserted into the at least one hole.

According to one or more embodiments, the electronic device 100 may identify (detect) an attribute of the plurality of ring-shaped housings 110, 120 rotating relative to one another. According to one or more embodiments, the electronic device 100 may include a magnet member 150 to detect a change in the magnetic force generated by the magnet member 150 when the plurality of ring-shaped housings 110, 120 rotate and to identify (detect) a rotation attribute of the plurality of ring-shaped housings 110, 120 based on the detected change in the magnetic force. According to one or more embodiments, the electronic device 100 may include a plurality of magnet members 150 to detect the rotation of at least one of the plurality of ring-shaped housings 110, 120.

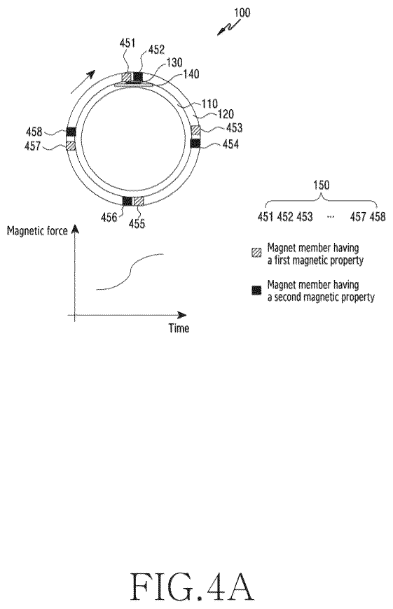

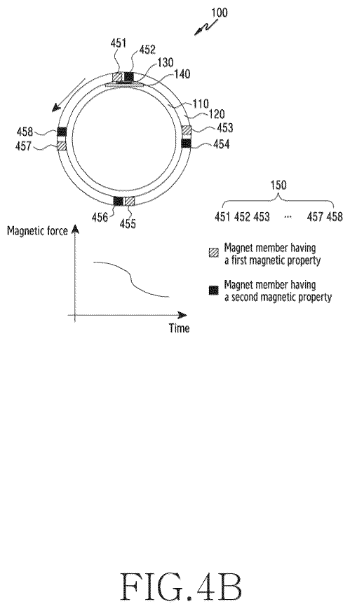

In one or more embodiments, the electronic device 100 may include a plurality of magnet members 150 and a hall sensor 130. In one or more embodiments, the hall sensor 130 and the plurality of magnet members 150 may be disposed in different housings among the housings 110, 120. In one or more embodiments, the hall sensor 130 included in the electronic device 100 may detect a change attribute in the magnetic force acting on the hall sensor 130 by the rotation of the plurality of magnet members 150 included in at least one of the plurality of housings 110, 120 when at least one of the plurality of housings 110, 120 rotates. For example, the change attribute in the magnetic force may include at least one of a speed of change in the magnetic force, whether the polarity of the magnetic force is changed, an amount of change in the magnetic force, an acceleration of change in the magnetic force, a magnitude of the magnetic force before change of the magnetic force, a magnitude of the magnetic force after change of the magnetic force, a pattern of change in the magnetic force or a graph of change in the magnetic force. The change attribute in the magnetic force and details of embodiments thereof will be described with reference to FIGS. 4 to 11.

According to one or more embodiments, at least one magnet member of the plurality of magnet members 150 may have a different magnetic property from that of at least one other magnet member of the plurality of magnet members 150. Details related thereto will be described with reference to FIGS. 4 to 8 and FIG. 10.

According to one or more embodiments, the plurality of magnet members 150 may include a plurality of magnet members which are arranged at different intervals. Detailed related thereto will be described with reference to FIGS. 4 to 9.

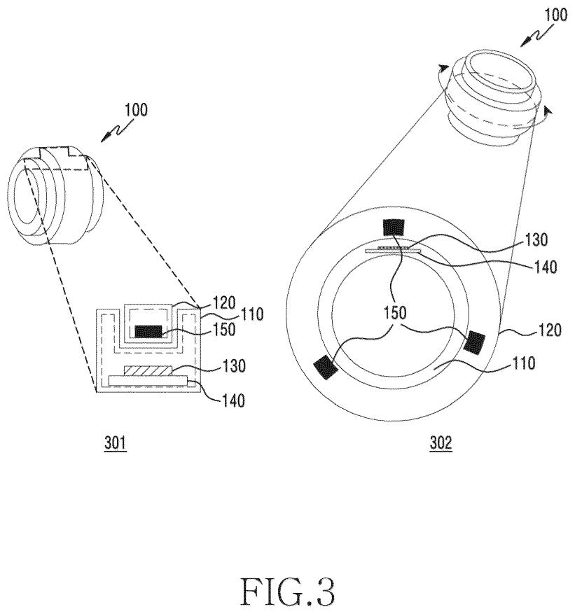

According to one or more embodiments, the electronic device 100 may include a first housing 110 and a second housing 120. In one or more embodiments, the first housing 110 and the second housing 120 may be formed in the same shape or may be formed in different shapes. According to one or more embodiments, the first housing 110 and the second housing 120 may have different sizes. In one or more embodiments, the first housing 110 and the second housing 120 may be formed in ring shapes with different diameters. However, embodiments are not limited thereto. Details of the structures of the first housing 110 and the second housing 120 and embodiments will be described with reference to FIG. 3.

According to one or more embodiments, a housing in which the hall sensor 130 is disposed may be different from a housing in which the plurality of magnet members 150 are disposed. In one or more embodiments, the hall sensor 130 and the plurality of magnet members 150 may be disposed in different housings, and the plurality of housings 110, 120 may be disposed to be rotatable relative to at least one other housing. In one or more embodiments, at least one of the plurality of housings 110, 120 may rotate relative to at least one other housing, such that the plurality of magnet members 150 in the housing rotate relative to at least one other housing. In one or more embodiments, the plurality of magnet members 150 may rotate relative to at least one other housing, such that gap between the hall sensor 130 and the plurality of magnet members 150 may be changed. In one or more embodiments, as the gap between the hall sensor 130 and the plurality of magnet members 150 are changed, the magnetic force acting on the hall sensor 130 may be changed. In one or more embodiments, the hall sensor 130 may detect the changed magnetic force. In one or more embodiments, the hall sensor 130 may detect a change attribute in the magnetic force.

The electronic device 100 according to one or more embodiments may identify (detect) an attribute of at least one of the plurality of housings 110, 120 rotating relative to at least one other housing, based on the change attribute in the magnetic force which is detected through the hall sensor 130. For example, the electronic device 100 may identify (detect) an attribute of the second housing 120 rotating relative to the first housing 110, based on the change attribute in the magnetic force which is detected through the hall sensor 130. Details related thereto will be described with reference to FIGS. 3 to 12.

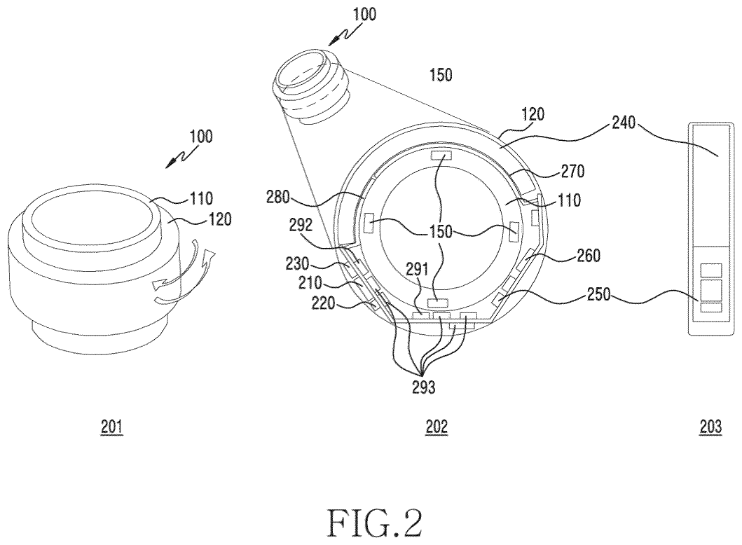

FIG. 2 is a perspective view of the electronic device 100 and a cross-sectional view illustrating inner components of the electronic device 100 according to one or more embodiments.

FIG. 2 is a perspective view illustrating components of the exterior of the electronic device 100 according to one or more embodiments.

Referring to FIG. 2, the housing of the electronic device 100 may include the first housing 110 and the second housing 120. In one or more embodiments, the first housing 110 may be rotatably coupled (connected) with the second housing 120. For example, the second housing 120 may have a ring shape that has a larger diameter than that of the first housing 110. For example, an inner side of the second housing 120 may be coupled (connected) with an outer side of the first housing 110. For example, the inner side of the second housing 120 may be coupled (connected) to face the outer side of the first housing 110. The structure of the housing of the electronic device 100 is not limited thereto.

FIG. 2 illustrates cross-sectional views 202, 203 as viewed from different directions to explain the inner components of the electronic device 100 according to one or more embodiments.

According to one or more embodiments, the electronic device 100 may include the first housing 110, the second housing 120, a plurality of magnet members 150, at least one processor 210, at least one memory 220, a communication module 230, a battery 240, a printed circuit board 250, a power management module 260, a charging interface 270, an antenna 280, an inertia sensor 291, a temperature sensor 282, or a sensor module 293.

According to one or more embodiments, the electronic device 100 may include at least one processor 210. According to one or more embodiments, a function or an operation that is performed by the electronic device 100 may be performed by at least one processor 210 by executing one or more instructions stored in the memory. According to one or more embodiments, a function or an operation of the electronic device 100 may be performed by one processor 210 by executing one or more instructions, or may be performed by a combination of a plurality of processors 210 by executing one or more instructions. According to one or more embodiments, the processor 210 may include a circuit to perform computation or to control other components of the electronic device 100. For example, the at least one processor 210 may include a central processing unit (CPU), a micro-processor unit (MPU), a graphic-processor unit (GPU), an application processor (AP), a communication processor (CP), a neural processing unit (NPU), a system on chip (SoC), an integrated circuit (IC), or a sensor hub which is configured to execute one or more instructions.

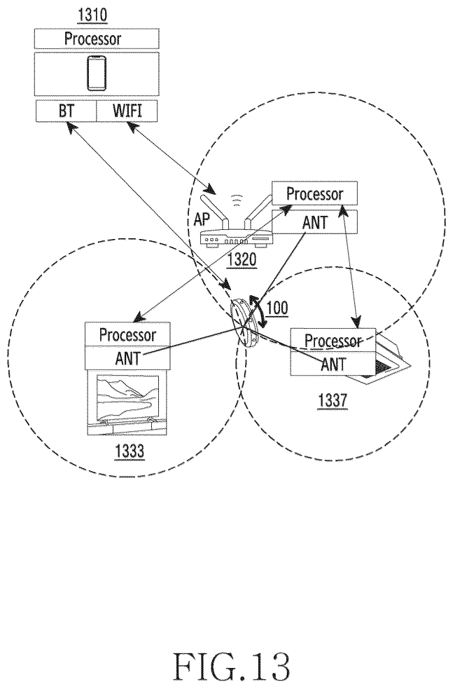

In one or more embodiments, the processor 210 may be configured to perform operations of the electronic device 100, which will be described below. In one or more embodiments, the at least one processor 210 may identify (detect) a change in the magnetic force detected by a hall sensor (for example, 130 of FIG. 1). In one or more embodiments, the at least one processor 210 may identify (detect) a change attribute in the magnetic force detected by the hall sensor 130. In one or more embodiments, the at least one processor 210 may identify (detect) a rotation attribute of the second housing 120 relative to the first housing 110, based on the identified change attribute in the magnetic force. In one or more embodiments, the at least one processor 210 may generate a signal corresponding to the identified rotation attribute. In one or more embodiments, the at least one processor 210 may transmit, to the communication module 230, an instruction to transmit the signal corresponding to the identified rotation attribute to a first external electronic device (for example, 1310 of FIG. 13).

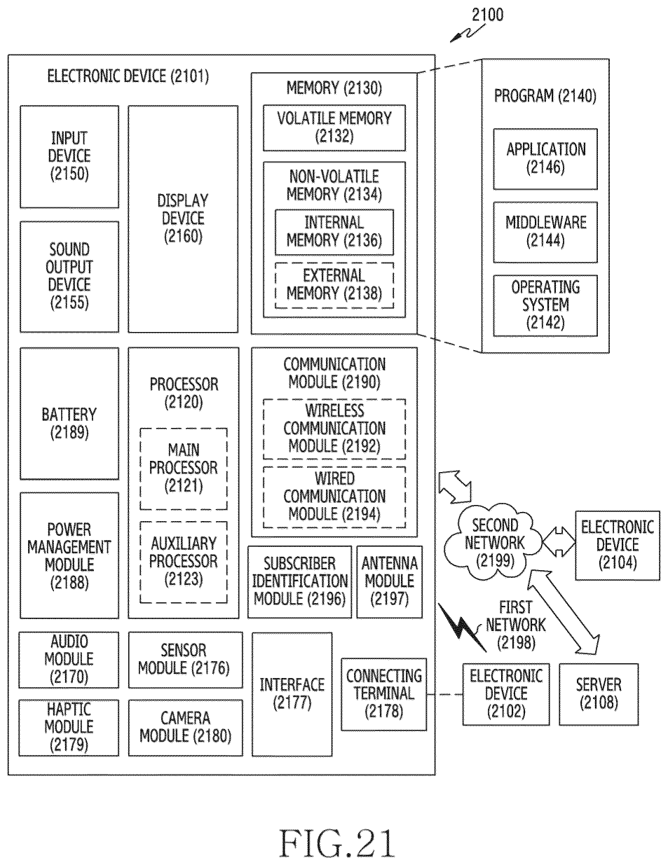

According to one or more embodiments, the electronic device 100 may include at least one memory 220. The memory 220 may store a variety of data that is used by at least one component (for example, a processor or a sensor module) of the electronic device 100. The data may include, for example, software (for example, a program (2140 of FIG. 21)) and input data or output data on a command related thereto. In one or more embodiments, the memory 220 may store data related to the rotation attribute of the housing corresponding to the change attribute in the magnetic force according to the configuration of the electronic device. In one or more embodiments, the memory 220 may store data related to whether the magnetic force acquired by at least one hall sensor (for example, 130 of FIG. 1) is changed and the change attribute in the magnetic force. In one or more embodiments, the memory 220 may provide data related to the change in the magnetic force stored therein to the processor 210.

According to one or more embodiments, the electronic device 100 may include at least one communication module 230. According to one or more embodiments, the at least one communication module 230 may exchange data with at least one external electronic device. For example, the at least one communication module 230 may exchange data with an external electronic device through such a technology as Bluetooth, Bluetooth low energy (BLE), ZigBee, ANT+, Wi-Fi, Cellular, near field communication (NFC), radio frequency identification (RFID), ultra-wideband (UWB) or global navigation satellite system (GNSS). However, the method of the at least one communication module 230 exchanging data with at least one external electronic device is not limited thereto.

In one or more embodiments, when the rotation attribute of the housing 110, 120 is identified by the at least one processor 210 and an instruction to transmit the signal corresponding to the identified rotation attribute to the external electronic device is received from the at least one processor 210, the at least one communication module 230 may transmit the signal corresponding to the identified rotation attribute to the external electronic device.

According to one or more embodiments, the electronic device 100 may include at least one battery 240. In one or more embodiments, the battery 240 may supply power to at least one component of the electronic device 100. For example, the battery 240 may include a rechargeable secondary battery or a fuel cell. For example, the battery 240 may be formed of a flexible material. For example, the battery 240 may include a plurality of battery packs. However, the type of the battery 240 of the electronic device is not limited thereto.

According to one or more embodiments, the electronic device 100 may include at least one printed circuit board (PCB) 250. For example, the PCB 250 may include a flexible printed circuit board (FPCB).

According to one or more embodiments, the electronic device 100 may include at least one power management module 260 (for example, a power management integrated circuit (PMIC)). In one or more embodiments, the power management module 260 may distribute power necessary for operations of the components included in the electronic device 100, and may control power.

According to one or more embodiments, the electronic device 100 may include at least one charging interface 270. For example, the charging interface 270 may provide at least one function of wired charging or wireless charging.

According to one or more embodiments, the electronic device 100 may include at least one antenna 280. In one or more embodiments, the at least one antenna 280 may provide a wireless communication function. For example, a part of the housings 110, 120 of the electronic device 100 may operate as the antenna 280. For example, a part of the outer side (for example, 110b) of the housings 110, 120 of the electronic device 100 may operate as the antenna 280.

According to one or more embodiments, the electronic device 100 may include at least one sensor module (for example, a sensor module 293 of FIG. 2, a sensor module 2176 of FIG. 21). The sensor module 293 may detect an operation state (for example, power or temperature) of the electronic device, or an external environment state (for example, a user state), and may generate an electrical signal or a data value corresponding to the detected state. According to one or more embodiments, the sensor module 293 may include, for example, a hall sensor (for example, 130 of FIG. 1), an inertia sensor 291, a photoplethysmography (PPG) sensor, a gesture sensor, a gyro sensor, an atmospheric pressure sensor, a magnetic sensor (for example, the hall sensor 130 of FIG. 1), an acceleration sensor, a grip sensor, a proximity sensor, a color sensor, an infrared (IR) sensor, a biometric sensor (for example, a PPG sensor), a temperature sensor 292, a humidity sensor, or an illuminance sensor.

In one or more embodiments, the electronic device 100 may include at least one inertia sensor 291. For example, the at least one inertia sensor 291 may include a gyroscope sensor. In one or more embodiments, the at least one inertia sensor 291 may detect movements of the electronic device 100. For example, the at least one inertia sensor 291 may detect the movements of the electronic device 100 with the electronic device 100 being worn by the user, thereby identifying a state of the user.

In one or more embodiments, the electronic device 100 may include at least one photoplethysmography (PPG) sensor. In one or more embodiments, the PPG sensor may include a light blood volume measurement sensor. In one or more embodiments, the PPG sensor may include a light emitter and a light receiver. For example, the PPG sensor may emit light to user's body through the light emitter, and may detect an amount of light reflected through the light receiver, thereby detecting a blood flow. According to one or more embodiments, the electronic device 100 may identify (detect) a state of the user through the PPG sensor while being worn by the user.

In one or more embodiments, the electronic device 100 may include at least one temperature sensor 292. In one or more embodiments, the electronic device 100 may detect a body temperature of the user wearing the electronic device through the temperature sensor 292. In one or more embodiments, the electronic device 100 may detect an internal temperature of the electronic device 100 through the temperature sensor 292.

FIG. 3 is a cross-sectional view illustrating arrangements of some components of the electronic device and movements of the electronic device according to one or more embodiments.

FIG. 3 illustrates cross-sectional views seen from different directions to explain internal components of the electronic device 100 according to one or more embodiments.

According to one or more embodiments, the electronic device 100 may include ring-shaped housings 110, 120. The electronic device 100 according to one or more embodiments may be worn on a user through a hole that is formed by the ring-shaped housings 110, 120. For example, the electronic device 100 may be worn on user's finger, wrist, neck, ankle, head, or waist by the ring-shaped housings 110, 120. For example, the electronic device 100 may be worn by the user such that the ring-shaped housings 110, 120 enclose user's body part. For example, the electronic device 100 may include two ring-shaped housings 110, 120 having the same axis on the center thereof. For example, the electronic device 100 may include two ring-shaped housings 110, 120 which are coupled (connected) to be rotatable about the same rotation axis relative to each other. In this case, the electronic device 100 may be worn on the user by the two ring-shaped housing structures. According to one or more embodiments, the electronic device 100 may include a plurality of ring-shaped housings 110, 120, and may be worn on the user by the plurality of ring-shaped housings 110, 120.

According to one or more embodiments, the electronic device 100 may include at least one hole penetrating through the electronic device 100. For example, referring to FIG. 3, the electronic device 100 may include a hole that is formed by the housings 110, 120. For example, a body part such as user's finger, wrist, arm or ankle may be inserted into the at least one hole.

According to one or more embodiments, the housings 110, 120 of the electronic device may include a first housing 110 and a second hosing 120. In one or more embodiments, the first housing 110 may be rotatably coupled (connected) with the second housing 120. For example, the first housing 110 may have a ring shape having a diameter smaller than that of the second housing 120. For example, the second housing 120 may have a ring shape having a diameter larger than that of the first housing 110. For example, an inner side of the second housing 120 may be coupled (connected) with an outer side of the first housing 110. For example, the inner side of the second housing 120 may be coupled (connected) to face the outer side of the first housing 110. For example, the first housing 110 may include a recess portion formed on the outer side thereof. For example, the recess portion of the first housing 110 may be formed on a portion where a surface of the second housing 120 that includes a trajectory along which the second housing 120 rotates relative to the first housing 110 and an outer surface of the first housing 110 meet each other. In this case, the inner side of the second housing 120 may be disposed in the recess portion of the outer side of the first housing 110. In this case, the second housing 120 may rotate relative to the first housing 110 along the recess portion of the outer side of the first housing 110. The structure of the housing of the electronic device 100 and the rotation method thereof are not limited thereto.

According to one or more embodiments, the plurality of ring-shaped housings 110, 120 may be coupled (connected) to be rotatable relative to at least one other housing. In this case, the plurality of ring-shaped housings 110, 120 may be rotated relative to at least one other housing by the user. In this case, at least one of the plurality of ring-shaped housings 110, 120 may be rotated relative to at least one other housing under force from the user. In one or more embodiments, at least one of the plurality of ring-shaped housings 110, 120 may be rotated relative to at least one other housing by receiving a rotating force from the user. For example, while the electronic device 100 is worn by the user, at least a part of the plurality of ring-shaped housings 110, 120 included in the electronic device 100 may be rotated relative to at least one other housing by receiving a force from the user. For example, while the electronic device 100 is worn on user's index finger, at least a part of the plurality of ring-shaped housings 110, 120 included in the electronic device 100 may be rotated relative to at least one other housing by receiving a force by user's thumb.

According to one or more embodiments, the electronic device 100 may detect an attribute of the plurality of ring-shaped housings 110, 120 rotating relative to each other. The electronic device 100 according to one or more embodiments may include a magnet member 150, such that, when the plurality of ring-shaped housings 110, 120 rotate, the electronic device 100 may detect a change in the magnetic force generated by the magnet member 150 and may identify (detect) a rotation attribute of the plurality of ring-shaped housings 110, 120 based on the detected change in the magnetic force. According to one or more embodiments, the electronic device 100 may include a plurality of magnet members 150, thereby detecting a rotation of at least one of the plurality of ring-shaped housings 110, 120.

In one or more embodiments, the electronic device 100 may include a hall sensor 130. In one or more embodiments, the hall sensor 130 may include a hall element. In one or more embodiments, the hall sensor 130 may detect the existence of a magnetic field, a location of occurrence, and a strength thereof. In one or more embodiments, the hall sensor 130 and the plurality of magnet members 150 may be disposed in different housings. In one or more embodiments, when at least one of the plurality of housings rotates, the hall sensor 130 included in the electronic device 100 may detect a change in the magnetic force acting on the hall sensor 130 according to the rotation of the plurality of magnet members 150 included in at least one of the plurality of housings. For example, when at least one of the plurality of housings rotates, the hall sensor 130 included in the electronic device 100 may detect a change attribute in the magnetic force acting on the hall sensor 130 by the rotation of the plurality of magnet members 150 included in at least one of the plurality of housings. For example, the change attribute in the magnetic force may include at least one of a speed of change in the magnetic force, whether the polarity of the magnetic force is changed, an amount of change in the magnetic force, an acceleration of change in the magnetic force, a magnitude of the magnetic force before change of the magnetic force, a magnitude of the magnetic force after change of the magnetic force, a pattern of change in the magnetic force or a graph of change in the magnetic force. The change attribute in the magenta force and details of the embodiments thereof will be described with reference to FIGS. 4 to 11.

According to one or more embodiments, at least one magnet member of the plurality of magnet members 150 may have a magnetic property different from that of at least one other magnet member. Details related thereto will be described with reference to FIGS. 4 to 8, and FIG. 10.

According to one or more embodiments, the plurality of magnet members 150 may include a plurality of magnet members 150 which are disposed at different intervals. For example, distances between adjacent magnet members 150 of the plurality of magnet members 150 may be different from each other. Details related thereto will be described with reference to FIGS. 4 to 9.

According to one or more embodiments, the electronic device 100 may include a first housing 110 and a second housing 120. In one or more embodiments, the first housing 110 and the second housing 120 may be formed in the same shape or may be formed in different shapes. According to one or more embodiments, the first housing 110 and the second housing 120 may have different sizes. In one or more embodiments, the first housing 110 and the second housing 120 may be formed in ring shapes having different diameters. For example, the ring-shaped first housing 110 may have a diameter shorter than that of the ring-shaped second housing 120. For example, the ring-shaped first housing 110 may have a diameter longer than that of the ring-shaped second housing 120. For example, the electronic device 100 may include two ring-shaped housings having the second housing 120 coupled (connected) to be rotatable relative to the first housing 110. For example, the electronic device 100 may include two ring-shaped housings having the first housing 110 coupled (connected) to be rotatable relative to the second housing 120. For example, the first housing 110 and the second housing 120 may have different diameters, and the second housing 120 may be disposed on the outer side of the electronic device 100 and the first housing 110 may be disposed on the inner side of the electronic device 100. For example, the second housing 120 may have a diameter larger than that of the first housing 110, and the second housing 120 may be disposed on the outer side of the electronic device 100, and the first housing 110 may be disposed on the inner side of the electronic device 100.

According to one or more embodiments, the housings 110, 120 of the electronic device 100 may include a structure that is hollow inside. In one or more embodiments, the housings 110, 120 of the electronic device 100 may be a structure that is filled inside. According to one or more embodiments, in the electronic device 100 including the ring-shaped housings 110, 120, the housings 110, 120 may have a structure that is hollow inside. For example, in the electronic device 100 including the ring-shaped housings 110, 120, the ring-shaped housings 110, 120 may be configured to form a ring-shaped inner space that is hollow inside. However, embodiments are not limited thereto.

According to one or more embodiments, the hall sensor 130 may be disposed in the ring-shaped housings 110, 120. In the electronic device 100 according to one or more embodiments, the ring-shaped housings 110, 120 may include a ring-shaped inner space that is hollow inside, and the hall sensor 130 may be disposed in the inner space. In the electronic device 100 according to one or more embodiments, the ring-shaped housings 110, 120 may include a ring-shaped inner space that is hollow inside, and a printed circuit board (PCB) may be disposed in the inner space. In one or more embodiments, the hall sensor 130 may be disposed adjacent to the printed circuit board 250. For example, the hall sensor 130 may be disposed to be in contact with the printed circuit board 250.

According to one or more embodiments, the hall sensor 130 and the plurality of magnet members 150 may be disposed in different housings 110, 120. For example, the hall sensor 130 may be disposed in the first housing 110, and the plurality of magnet members 150 may be disposed in the second housing 120. For example, the hall sensor 130 may be disposed in the second housing 120, and the plurality of magnet members 150 may be disposed in the first housing. However, embodiments are not limited thereto.

In one or more embodiments, the plurality of magnet members 150 may be disposed at positions adjacent to the hall sensor 130. For example, when the hall sensor 130 is disposed in the first housing 110, the plurality of magnet members 150 may be disposed at positions adjacent to and facing the first housing 110 in the second housing 120. Accordingly, when the second housing 120 rotates relative to the first housing 110, the change in the magnetic force which is detected by the hall sensor 130 may be more accurately detected due to the rotation of the plurality of magnet members 150. However, the arrangement method of the plurality of magnet members 150 and the hall sensor 130 is not limited thereto.

In one or more embodiments, the hall sensor 130 and the plurality of magnet members 150 may be disposed in different housings 110, 120, and the plurality of housings 110, 120 may be disposed to be rotatable relative to at least one other housing. For example, the hall sensor 130 may be disposed in the first housing 110 and the plurality of magnet members 150 may be disposed in the second housing 120, and the first housing 110 and the second housing 120 may be disposed to be rotatable relative to each other. For example, the hall sensor 130 may be disposed in the second housing 120 and the plurality of magnet members 150 may be disposed in the first housing 110, and the first housing 110 and the second housing 120 may be disposed to be rotatable relative to each other. In this case, as at least one of the plurality of housings 110, 120 rotates relative to at least one other housing, the plurality of magnet members 150 in the housing may rotate relative to at least one other housing. For example, as the second housing 120 rotates relative to the first housing 110, the plurality of magnet members 150 in the second housing 120 may rotate relative to the first housing 110 and the hall sensor 130 in the first housing 110. In one or more embodiments, as the plurality of magnet members 150 rotate relative to at least one other housing, the gap between the hall sensor 130 and the plurality of magnet members 150 may be changed. For example, as the plurality of magnet members 150 in the second housing 120 rotate relative to the first housing 110, the gap with the hall sensor 130 in the first housing 110 may be changed. In one or more embodiments, as the gap between the hall sensor 130 and the plurality of magnet members 150 is changed, the magnetic force acting on the hall sensor 130 may be changed. In one or more embodiments, the hall sensor 130 may detect the changed magnetic force. In one or more embodiments, the hall sensor 130 may detect a change attribute in the magnetic force. For example, the change attribute in the magnetic force may include at least one of a speed of change in the magnetic force, whether the polarity of the magnetic force is changed, an amount of change in the magnetic force, an acceleration of change in the magnetic force, a magnitude of the magnetic force before change of the magnetic force, a magnitude of the magnetic force after change of the magnetic force, a pattern of change in the magnetic force or a graph of change in the magnetic force.

The electronic device 100 according to one or more embodiments may identify (detect) an attribute of at least one of the plurality of housings 110, 120 rotating relative to at least one other housing, based on the change attribute in the magnetic force which is detected via the hall sensor 130. For example, the electronic device 100 may identify (detect) an attribute of the second housing 120 rotating relative to the first housing 110, based on the change attribute in the magnetic force which is detected via the hall sensor 130. In one or more embodiments, the operation of identifying, by the electronic device 100, a rotation attribute of at least one of the plurality of housings 110, 120 based on the change attribute in the magnetic force may be performed by a processor (for example, 210 of FIG. 2). For example, the electronic device 100 may identify (detect) a rotation attribute of the second housing 120 relative to the first housing 110, based on the change attribute in the magnetic force, through the processor (for example, 210 of FIG. 2). For example, the rotation attribute of the second housing 120 relative to the first housing 110 may include a speed at which the second housing 120 rotates relative to the first housing 110, a direction in which the second housing 120 rotates relative to the first housing 110, or a position of the hall sensor 130 relative to the first housing 110 that is displaced in response to the rotation. However, embodiments are not limited thereto. Details related thereto will be described with reference to FIGS. 4 to 12.

FIGS. 4A and 4B are views to explain a method by which the magnet members 150 are arranged in the electronic device, and a method of identifying a rotation attribute of a housing through a change attribute in the magnetic force caused by rotation of the housing.

In one or more embodiments, when at least one of the plurality of housings rotates, the hall sensor 130 included in the electronic device 100 may detect a change attribute in the magnetic force acting on the hall sensor 130 by the rotation of the plurality of magnet members 150 included in at least one of the plurality of housings.

FIGS. 4A and 4B illustrate a change attribute in the magnetic force when the second housing 120 rotates in different directions relative to the first housing 110.

According to one or more embodiments, at least one magnet member of the plurality of magnet members 150 may have a different magnetic property from that of at least one other magnet member.

In one or more embodiments, the magnet members 150 having different magnetic properties may include the magnet members 150 having different magnetic forces acting on the hall sensor 130. In one or more embodiments, the magnet members 150 having different magnetic properties may include the magnet members 150 have different polarities of magnetic forces acting on the hall sensor 130. For example, referring to FIGS. 4A and 4B, the plurality of magnet members 150 may include magnet members 451, 453, 455, 457 having a first magnetic property and magnet members 452, 454, 456, 458 having a second magnetic property. For example, the magnet members 451, 453, 455, 457 having the first magnetic property may have a relatively strong magnetic property than the magnet members 452, 454, 456, 458 having the second magnetic property. For example, the magnet members 451, 453, 455, 457 having the first magnetic property may have the opposite polarity to that of the magnet members 452, 454, 456, 458 having the second magnetic property.

According to one or more embodiments, the plurality of magnet members 150 may include a plurality of magnet members 150 which are arranged at different intervals.

In one or more embodiments, at least a part of the plurality of magnet members 150 may be a plurality of magnet members 150 which are arranged at different intervals. In one or more embodiments, each of the gaps between the plurality of magnet members 150 may be different. In one or more embodiments, the plurality of magnet members 150 may be arranged such that the gaps between the plurality of magnet members 150 gradually increase. In one or more embodiments, the plurality of magnet members 150 may be arranged such that the gaps between the plurality of magnet members 150 gradually decrease.

In one or more embodiments, the plurality of magnet members 150 may include a plurality of magnet member sets. According to one or more embodiments, the magnet member sets may include magnet members 150 having different magnetic properties. According to one or more embodiments, the gaps between the magnet members 150 included in the same magnet member set may be shorter than the gaps between the magnet members 150 included in different magnet member sets. The electronic device 100 according to one or more embodiments may include a first magnet member set and a second magnet member set. In this case, the gap between the magnet members in the first magnet member set may be shorter than the gap between the first magnet member set and the second magnet member set.

For example, referring to FIG. 4, the plurality of magnet members 150 may include a plurality of magnet member sets including one of each of the magnet members 451, 453, 455, 457 having the first magnetic property and the magnet members 452, 454, 456, 458 having the second magnetic property. In this case, the magnet members 451, 453, 455, 457 having at least one first magnetic property, and the magnet members 452, 454, 456, 458 having at least one second magnetic property may be included in the same magnet member set. The first magnetic property and the second magnetic property may be the same as or different from each other. However, embodiments related to the plurality of magnet member sets included in the plurality of magnet members 150 are not limited thereto.

According to one or more embodiments, the electronic device 100 may control the hall sensor 130 to identify (detect) a change in the magnetic force that is generated by the plurality of magnet members 150 and is detected by the hall sensor 130 as the second housing 120 rotates relative to the first housing 110 by a user input. In one or more embodiments, the electronic device 100 may control the hall sensor 130 to identify (detect) a change in the magnetic force that is generated by the plurality of magnet members 150 and is detected by the hall sensor 130 as the first housing 110 rotates relative to the second housing 120 by a user input.

In one or more embodiments, when at least one of the plurality of housings rotates, the hall sensor 130 included in the electronic device 100 may detect a change attribute in the magnetic force acting on the hall sensor 130 by the rotation of the plurality of magnet members 150 included in at least one of the plurality of housings. For example, the change attribute in the magnetic force may include at least one of a speed of change in the magnetic force, whether the polarity of the magnetic force is changed, an amount of change in the magnetic force, an acceleration of change in the magnetic force, a magnitude of the magnetic force before change of the magnetic force, a magnitude of the magnetic force after change of the magnetic force, a pattern of change in the magnetic force or a graph of change in the magnetic force.

Referring to FIG. 4A, the second housing 120 may rotate in a first direction (anti-clockwise) relative to the first housing 110. In this case, the magnet member 452 having the second magnetic property may pass through a portion adjacent to the hall sensor 130 first, and then, the magnet member 451 having the first magnetic property may pass through the portion adjacent to the hall sensor 130. In this case, the hall sensor 130 may detect the magnetic force generated by the magnet member 452 having the second magnetic property, first, and then, may detect the magnetic force generated by the magnet member 451 having the first magnetic property.

For example, at a position closest to the hall sensor 130, the magnet members 150 having the second magnetic property may generate a magnetic force relatively smaller than that of the magnet members 150 having the first magnetic property. In this case, when the second housing 120 rotates in the first direction relative to the first housing 110, the magnet member 452 having the second magnetic property which generates a relatively small magnetic force may pass through the portion adjacent to the hall sensor 130 before the magnet member 451 having the first magnetic property which generates a relatively large magnetic force, and then, the magnet member 451 having the first magnetic property may pass through the portion adjacent to the hall sensor 130. Accordingly, when the second housing 120 rotates in the first direction relative to the first housing 110, the hall sensor 130 may detect the relatively small magnetic force first, and may detect the relatively great magnetic force later.

Referring FIG. 4B, the second housing 120 may rotate in a second direction (clockwise) which is opposite to the first direction, relative to the first housing 110. In this case, the magnet member 451 having the first magnetic property may pass through the portion adjacent to the hall sensor 130, first, and then, the magnet member 452 having the second magnetic property may pass through the portion adjacent to the hall sensor 130. In this case, the hall sensor 130 may detect the magnetic force generated by the magnet member 451 having the first magnetic property, first, and then, may detect the magnetic force generated by the magnet member 452 having the second magnetic property.

For example, at a position closest to the hall sensor 130, the magnet members 150 having the second magnetic property may generate a relatively smaller magnetic force than the magnet members 150 having the first magnetic property. In this case, when the second housing 120 rotates in the second direction which is opposite to the first direction relative to the first housing 110, the magnet member 451 having the first magnetic property that generates a relatively great magnetic force may pass through the portion adjacent to the hall sensor 130 before the magnet member 452 having the second magnetic property that generates a relatively large magnetic force, and then, the magnet member 452 having the second magnetic property may pass through the portion adjacent to the hall sensor 130. Accordingly, referring to FIG. 4B, when the second housing 120 rotates in the second direction which is opposite to the first direction relative to the first housing 110, the hall sensor 130 may detect the relatively great magnetic force, first, and may detect the relatively small magnetic force later.

According to one or more embodiments, the electronic device 100 may identify (detect) an attribute of the plurality of ring-shaped housings rotating relative to each other.

For example, the attribute of the plurality of ring shaped housings rotating relative to each other may include information on a speed at which the second housing 120 rotates relative to the first housing 110, a direction in which the second housing 120 rotates relative to the first housing 110, a position of the hall sensor 130 relative to the first housing 110 that is displaced in response to the rotation, a relative position of the second housing 120 to the first housing 110 before rotation, or a relative position of the second housing 120 to the first housing 110 after rotation. However, embodiments are not limited thereto.

Referring to FIG. 4A, the second housing 120 may rotate in the first direction relative to the first housing 110. In this case, the magnet member 452 having the second magnetic property may pass through the portion adjacent to the hall sensor 130 first, and then, the magnetic member 451 having the first magnetic property may pass through the portion adjacent to the hall sensor 130. In this case, the electronic device 100 may first detect the magnetic force generated by the magnetic member 452 having the second magnetic property through the hall sensor 130, and then, may detect the magnetic force generated by the magnet member 451 having the first magnetic property and an attribute of change in the magnetic force. In this case, the electronic device 100 may identify (detect) that the direction in which the second housing 120 rotates relative to the first housing 110 is the first direction, based on the characteristic of the magnet member 451 having the first magnetic property, the characteristics of the magnet member 452 having the second magnetic property, and the magnetic force detected through the hall sensor 130 and the attribute of change in the magnetic force.

For example, at a position closest to the hall sensor 130, the magnet members 150 having the second magnetic property may generate a relatively smaller magnetic force than the magnet members 150 having the first magnetic property. In this case, when the second housing 120 rotates in the first direction relative to the first housing 110, the magnet member 452 having the second magnetic property that generates a relatively small magnetic force may pass through the portion adjacent to the hall sensor 130 before the magnet member 451 having the first magnetic property that generates a relatively great magnetic force, and thereafter, the magnet member 451 having the first magnetic property may pass through the portion adjacent to the hall sensor 130. Accordingly, referring to FIG. 4A, when the second housing 120 rotates in the first direction relative to the first housing 110, the hall sensor 130 may first detect the relatively small magnetic force, and may detect the relatively large magnetic force later. In this case, the electronic device 100 may identify (detect) that the direction in which the second housing 120 rotates relative to the first housing 110 is the first direction, based on the relatively small magnetic force being detected first by the hall sensor 130 and the relatively great magnetic force being detected later.

Referring to FIG. 4B, the second housing 120 may rotate in the second direction opposite to the first direction relative to the first housing 110. In this case, the magnet member 451 having the first magnetic property may pass through the portion adjacent to the hall sensor 130 first, and then, the magnet member 452 having the second magnetic property may pass through the portion adjacent to the hall sensor 130. In this case, the hall sensor 130 may detect the magnetic force generated by the magnet member 451 having the first magnetic property first, and then, may detect the magnetic force generated by the magnet member 452 having the second magnetic property. In this case, the electronic device 100 may identify (detect) that the direction in which the second housing 120 rotates relative to the first housing is the second direction, based on the characteristic of the magnet member 451 having the first magnetic property, the characteristic of the magnet member 452 having the second magnetic property, and the magnetic force detected through the hall sensor 130 or the attribute of change in the magnetic force.

For example, at a position closest to the hall sensor 130, the magnet members 452, 454, 456, 458 having the second magnetic property may generate a relatively smaller magnetic force than the magnet members 451, 453, 455, 457 having the first magnetic property. In this case, when the second housing 120 rotates in the second direction which is opposite to the first direction relative to the first housing 110, the magnet member 451 having the first magnetic property that generates a relatively great magnetic force may pass through the portion adjacent to the hall sensor 130 before the magnet member 452 having the second magnetic property that generates a relatively large magnetic force, and thereafter, the magnet member 452 having the second magnetic property may pass through the portion adjacent to the hall sensor 130. Accordingly, referring to FIG. 4B, when the second housing 120 rotates in the second direction which is opposite to the first direction relative to the first housing 110, the hall sensor 130 may first detect the relatively great magnetic force, and may detect the relatively small magnet force later. In this case, the electronic device 100 may identify (detect) that the direction in which the second housing 120 rotates relative to the first housing 110 is the second direction, based on the relatively great magnetic force being detected first by the hall sensor 130 and the relatively small magnetic force being detected later.

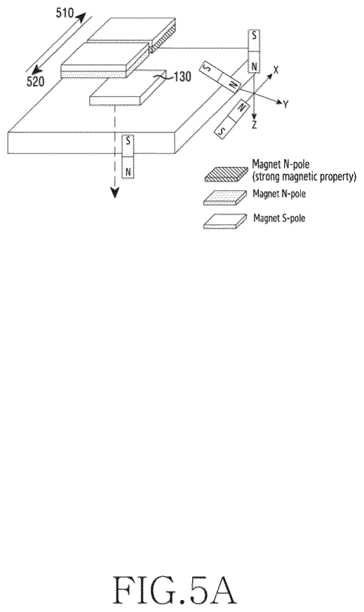

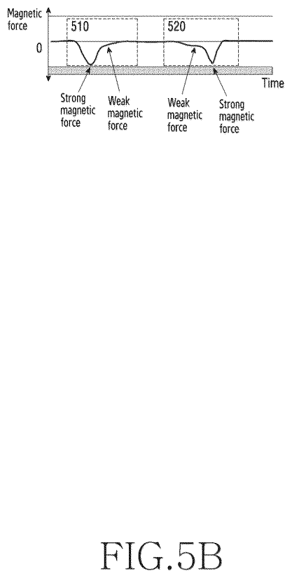

FIGS. 5A and 5B illustrate a method by which magnet members 150 are arranged in the electronic device 100, and a method of identifying a rotation attribute of a housing through a change attribute in the magnetic force according to one or more embodiments.

FIG. 5A illustrates an inner structure of the electronic device 100 which is rotatable in a positive direction 510 or a negative direction 520 on the x-axis. In FIG. 5A, the hall sensor 130 may be disposed in the z-axis direction or on a portion adjacent to the z-axis direction relative to the magnet members 150 with reference to a state in which the plurality of magnet members 150 are disposed closest thereto. For example, the plurality of magnet members 150 may be disposed in the second housing 120, and the hall sensor 130 may be disposed at a position adjacent to the plurality of magnet members 150 in the z-axis direction in the first housing 110.

FIG. 5B illustrates a graph showing a change attribute in the magnetic force when the second housing 120 of the electronic device 100 rotates in the positive direction 510 on the x-axis relative to the first housing 110, and a graph showing a change attribute in the magnetic force when the second housing 120 of the electronic device 100 rotates in the negative direction 520 of the x-axis relative to the first housing 110.

Referring to FIG. 5A, the plurality of magnet members 150 may include a plurality of magnet members 150 having different magnitudes of magnetic properties. The plurality of magnet members 150 may include a magnetic member set which is comprised of a plurality of magnet members 150. For example, the magnet member set may include a plurality of magnet members 150 which have different magnitudes of magnetic properties. For example, a plurality of magnet members 150 included in the same magnet member set may be disposed to be in contact with one another, or may be disposed to be spaced apart from one another. For example, the plurality of magnet members 150 included in the same magnet member set may be arranged in the second housing 120 in a direction parallel to the direction in which the second housing 120 rotates relative to the first housing 110. For example, the plurality of magnet members 150 may include at least one magnet member set which is comprised of two magnet members 150 having different magnitudes of magnetic properties. The two magnet members 150 having different magnitudes of magnetic properties may be disposed such that portions having the same polarity in the magnet members are positioned in a direction adjacent to the hall sensor 130 with reference to the state in which the magnet members 150 are positioned closest to the hall sensor 130. For example, the two magnet members 150 having different magnitudes of magnetic properties may be disposed such that the portions having the N-pole in the magnet members are positioned in a direction adjacent to the hall sensor 130 with reference to the state in which the magnet members 150 are positioned closest to the hall sensor 130.

For example, referring to FIG. 5, the attribute of the magnetic force detected by the hall sensor 130 may be different according to the direction of rotation of the second housing 120 relative to the first housing 110. The plurality of magnet members 150 may include at least one magnet member set which is comprised of two magnet members 150 having different magnitudes of magnetic properties. In this case, the two magnet members 150 having different magnitudes of magnetic properties may be disposed such that the portion having the N-pole on each magnet member is positioned in a direction adjacent to the hall sensor 130 with reference to the state in which the magnet members 150 are positioned closest to the hall sensor 130. In addition, the magnet member that has a relatively large magnitude of a magnetic property out of the two magnet members 150 of the different magnitudes of the magnetic properties may be disposed to be positioned in the positive direction on the x-axis with reference to the magnet member that has a relatively small magnitude of a magnetic property.

For example, when the second housing 120 rotates relative to the first housing 110, some of the magnet members 150 may rotate toward the positive direction 510 on the x-axis in the portion closest to the hall sensor 130. In this case, the magnet member that has the relatively large magnitude of the magnetic property may reach the position adjacent to the hall sensor before the magnet member that has the relatively small magnitude of the magnetic property. In this case, as shown in FIG. 5B, the hall sensor 130 may first detect the relatively strong magnetic force, and may detect the relatively weak magnetic force later. The electronic device 100 may identify (detect) a direction in which the second housing 120 rotates relative to the first housing 110, based on the relatively strong magnetic force being detected before the relatively weak magnetic force.

For example, when the second housing 120 rotates with reference to the first housing 110, some of the magnet members 150 may rotate toward the negative direction 520 on the x-axis in the portion closest to the hall sensor 130. In this case, the magnet member that has the relatively small magnitude of the magnetic property may reach the position adjacent to the hall sensor 130 before the magnet member that has the relatively large magnitude of the magnetic property. Accordingly, as shown in FIG. 5B, the hall sensor 130 may first detect the relatively weak magnetic force, and may detect the relatively strong magnetic force later. The electronic device 100 may identify (detect) a direction in which the second housing 120 rotates relative to the first housing 110, based on the relatively weak magnetic force being detected through the hall sensor 130 before the relatively strong magnetic force.

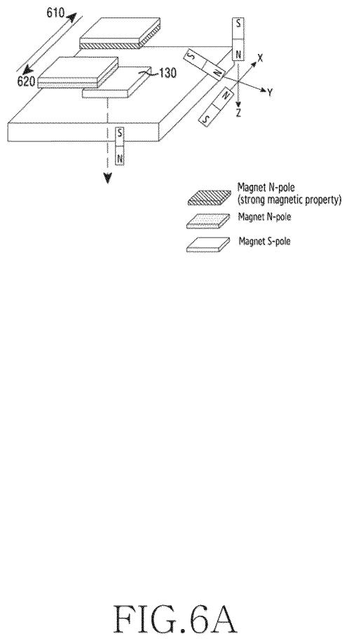

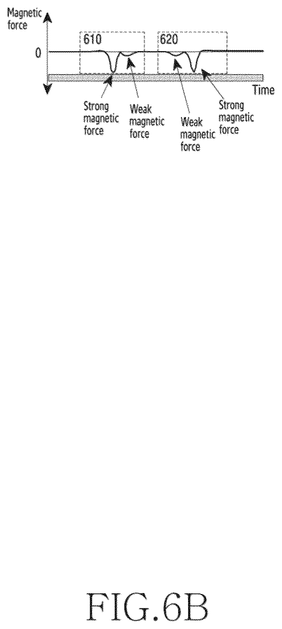

FIGS. 6A and 6B are views to explain an example of arrangements of magnet members 150 in the electronic device, and an example of identifying a rotation attribute of a housing through a change attribute in the magnetic force according to one or more embodiments.

FIG. 6A may correspond to FIG. 5A, and FIG. 6B may correspond to FIG. 5B. Accordingly, redundant explanations may be omitted and the difference between the embodiment shown in FIGS. 5A and 5B and the embodiment shown in FIGS. 6A and 6B will be highlighted.

Compared to the embodiment illustrated in FIGS. 5A and 5B, the embodiment of FIGS. 6A and 6B has magnet members 150 which are included in a single magnet member set and are positioned at a relatively long distance.

In one or more embodiments, the plurality of magnet members 150 included in the single magnet member set may be disposed adjacent to one another or may be disposed at relatively long distances. As shown in FIG. 6A, the plurality of magnet members 150 may be arranged at relatively longer intervals than in the embodiment illustrated in FIG. 5A. In this case, a time period during which a relatively strong magnetic force is detected and a time period during which a relatively weak magnetic force is detected may be relatively clearly distinguished from each other. In this case, referring to the graphs of the change in the magnetic force shown in FIG. 5B and FIG. 6B, in the graph of the change in the magnetic force shown in FIG. 6B, the period during which a relatively strong magnetic force is detected and the period during which a relatively weak magnetic force is detected may be identified more clearly. Accordingly, compared to when the plurality of magnet members 150 are completely in contact with one another or are positioned at relatively short distances, when the plurality of magnet members 150 are positioned at relatively long distances, the change in the magnetic force may be more clearly identified, so that malfunction may be minimized and the accuracy of identifying the rotation attribute of the housing may be enhanced. Accordingly, the gaps between the plurality of magnet members may be set to a predetermined distance or longer in order to enhance the accuracy of identifying the rotation attribute of the housing and to reduce the probability of malfunction.

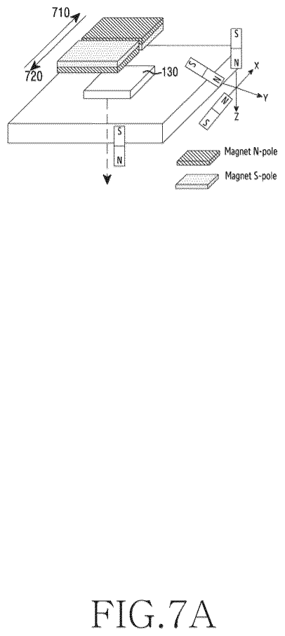

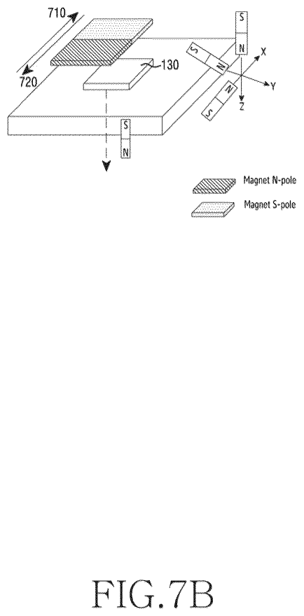

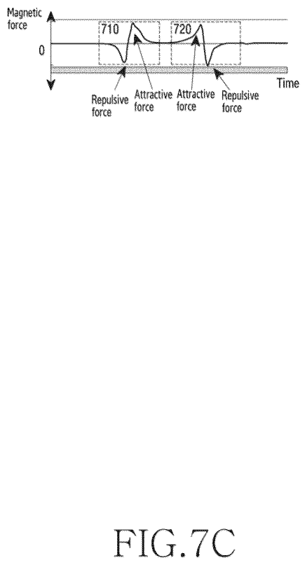

FIGS. 7A, 7B, and 7C are views to explain an example of arrangements of magnet members 150 in the electronic device, and an example of identifying a rotation attribute of a housing through a change attribute in the magnetic force according to one or more embodiments.

Referring to FIG. 7A, the plurality of magnet members 150 may include a plurality of magnet members 150 having different polarities. In one or more embodiments, the plurality of magnet members 150 may be disposed in the second housing 12 such that portions of different polarities in the respective magnet members are adjacent to the first housing 110. For example, the plurality of magnet members 150 may include a first magnet member and a second magnet member, and may be disposed in the second housing 120, such that a portion of the first magnet member that has a first polarity and a portion of the second magnet member that has a second polarity are adjacent to the first housing 110. In this case, the portion of the first magnet member having the first polarity and the portion of the second magnet member having the second polarity may be disposed in a direction adjacent to the hall sensor 130 in the first housing 110. For example, the first polarity and the second polarity may be opposite polarities. For example, the plurality of magnet members 150 may include a first magnet member and a second magnet member, and may be disposed in the second housing 120 such that the N-pole portion of the first magnet member and the S-pole portion of the second magnet member are adjacent to the first housing 110.

Referring to FIG. 7C, the N-pole portion and the S-pole portion of one magnet member may be disposed in the second housing 120 to be adjacent to the first housing 110. In one or more embodiments, as shown in FIG. 7C, portions of the different polarities in one magnet member may be arranged on the second housing 120 along a direction in which the second housing 120 rotates relative to the first housing 110. The plurality of magnet members 150 may include a magnet member set which is comprised of a plurality of magnet members 150. For example, the magnet member set may include a plurality of magnet members 150 with different polarities. For example, the plurality of magnet members 150 included in the same magnet member set may be disposed to be in contact with one another, or may be disposed to be spaced apart from one another. For example, the plurality of magnet members 150 included in the same magnet member set may be arranged such that portions having different polarities are disposed on the second housing 120 along the direction in which the second housing 120 rotates relative to the first housing 110. For example, two magnet members 150 may be disposed such that the portions having different polarities in the respective magnet members are positioned in the direction adjacent to the hall sensor 130 with reference to the state in which the magnet members 150 are positioned closest to the hall sensor 130.

Referring to the examples of FIGS. 7A, 7B, and 7C, the attribute of the magnetic force detected by the hall sensor 130 may vary according to the direction in which the second housing 120 rotates relative to the first housing 110. In one or more embodiments, the plurality of magnet members 150 may include at least one magnet member set which is comprised of two magnet members 150 with different polarities. The two magnet members 150 with different polarities may be disposed such that the N-pole portion and the S-pole portion of the magnet members are positioned in the direction adjacent to the hall sensor 130 with reference to the state in which the magnet members 150 are positioned closest to the hall sensor 130. The magnet member having the N-pole portion that is disposed in the direction adjacent to the hall sensor 130 out of the two magnet members 150 with different polarities may be disposed to be positioned in the positive direction on the x-axis with reference to the magnet member having the S-pole portion that is disposed in the direction adjacent to the hall sensor 130.

Referring to FIGS. 7A and 7C, when the second housing 120 rotates relative to the first housing 110, some magnet members 150 may rotate toward the positive direction 710 on the x-axis in the portion closest to the hall sensor 130. In this case, the S-pole portion of the magnet member may reach the position adjacent to the hall sensor 130 before the N-pole portion. Accordingly, referring to FIG. 7B, when the S-pole portion of a magnet member in the hall sensor 130 is disposed in the direction adjacent to the second housing 120 (for example, the negative direction on the z-axis in FIGS. 7A and 7C), the hall sensor 130 may detect the repulsive force first and may detect the attractive force later. The electronic device may identify (detect) the direction in which the second housing 120 rotates relative to the first housing 110, based on the repulsive force being detected before the attractive force through the hall sensor 130.

Referring to FIGS. 7A and 7B, when the second housing 120 rotates relative to the first housing 110, some magnet members 150 may rotate toward the negative direction 702 on the x-axis in the portion closest to the hall sensor 130. In this case, the N-pole portion of the magnet member may reach the position adjacent to the hall sensor 130 before the S-pole portion of the magnet member. Accordingly, referring to FIG. 7B, when the S-pole portion of the magnet member in the hall sensor 130 is disposed in the direction adjacent to the second housing 120, the hall sensor 130 may detect the attractive force first and may detect the repulsive force later. The electronic device 100 may identify (detect) the direction in which the second housing 120 rotates relative to the first housing 110, based on the attractive force being detected before the repulsive force through the hall sensor 130.

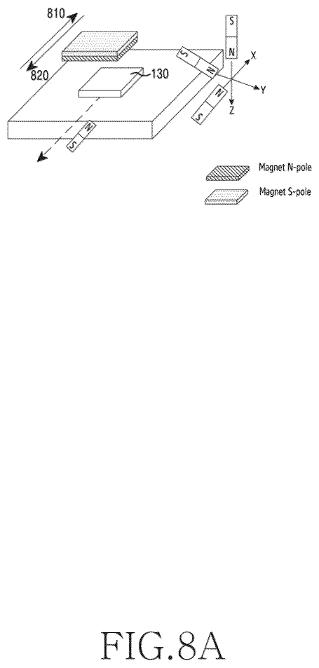

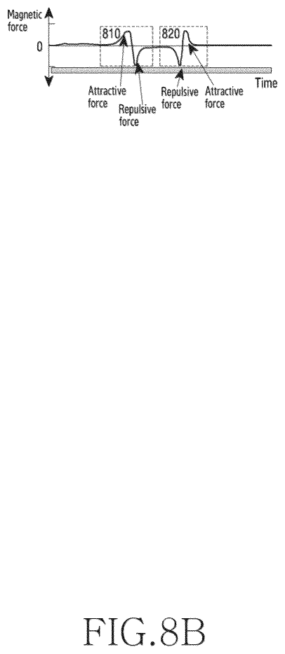

FIGS. 8A and 8B illustrate an example of arrangements of magnet members 150 in the electronic device, and an example of identifying a rotation attribute of a housing through a change attribute in the magnetic force according to one or more embodiments.

In the embodiments of FIGS. 4A to 7C, the hall sensor 130 and the plurality of magnet members 150 are disposed in different housings. However, according to one or more embodiments, an arrangement direction of a magnet member in the hall sensor 130 may be changed as shown in FIGS. 8A and 8B.

Referring to FIG. 8A, the N-pole portion and the S-pole portion of the magnet member in the hall sensor 130 may be disposed along the direction in which the first housing 110 rotates relative to the second housing 120. In one or more embodiments, as shown in FIG. 8A, the portions of different polarities in one magnet member may be disposed in the hall sensor 130 along the direction in which the first housing 110 rotates relative to the second housing 120 (for example, in the +x-axis direction or-x-axis direction of FIG. 8A).

Referring to the example of FIGS. 8A and 8B, the attribute of the magnetic force detected by the hall sensor 130 may be different according to the direction in which the second housing 120 rotates relative to the first housing 110.

For example, referring to FIG. 8A, when the second housing 120 rotates relative to the first housing 110, some magnet members may rotate toward the positive direction 810 on the x-axis in the portion closest to the hall sensor 130. In this case, the S-pole portion of the magnet member in the hall sensor 130 may reach the position adjacent to the hall sensor 130 before the N-pole portion. Accordingly, referring FIG. 8B, when the S-pole portion of the magnet member in the hall sensor 130 is disposed in a direction adjacent to the second housing 120 (for example, the negative direction on the z-axis in FIG. 8A), the hall sensor 130 may detect the attractive force first, and may detect the repulsive force later. The electronic device 100 may identify (detect) the direction in which the second housing 120 rotates relative to the first housing 110, based on the repulsive force being detected before the attractive force through the hall sensor 130.

Referring to FIG. 8A, when the second housing 120 rotates relative to the first housing 110, some magnet members 150 may rotate toward the negative direction 820 on the x-axis in the portion closest to the hall sensor 130. In this case, the N-pole portion of the magnet member may reach the position adjacent to the hall sensor 130 before the S-pole portion. Accordingly, referring to FIG. 8B, when the S-pole portion of the magnet member in the hall sensor 130 is disposed in the direction adjacent to the second housing 120, the hall sensor 130 may detect the repulsive force first and may detect the attractive force later. The electronic device 100 may identify (detect) the direction in which the second housing 120 rotates relative to the first housing 110, based on the attractive force being detected before the repulsive force through the hall sensor 130.

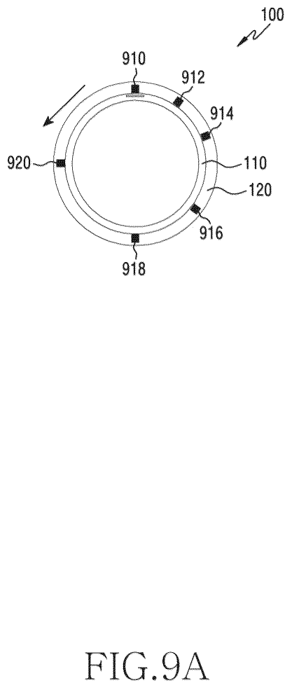

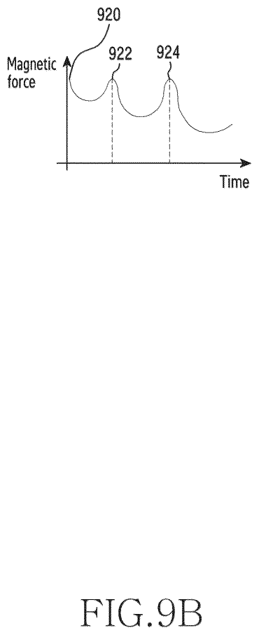

FIGS. 9A and 9B illustrate example of arrangements of magnet members 150 at different intervals in the electronic device, and a change attribute in in the magnetic force according to one or more embodiments.

FIG. 9A illustrates an example of arrangements of magnet members 150 at different intervals in the electronic device 100 according to one or more embodiments, and FIG. 9B is a graph showing a change attribute in the magnetic force while the second housing 120 is rotating relative to the first housing 110 when the magnet members 150 are arranged at different intervals as shown in FIG. 9A.

According to one or more embodiments, the plurality of magnet members 150 may include a plurality of magnet members 150 which are arranged at different intervals.

In one or more embodiments, at least a part of the plurality of magnet members 150 may be a plurality of magnet members 150 which are arranged at different intervals. In one or more embodiments, the gaps between the plurality of magnet members 150 may all be different. In one or more embodiments, the plurality of magnet members 150 may be arranged such that the gaps between the plurality of magnet members 150 gradually increase. In one or more embodiments, the plurality of magnet members 150 may be arranged such that the gaps between the plurality of magnet members 150 gradually decrease. For example, when N magnet members 150 are arranged in the electronic device 100, the plurality of magnet members 150 may include a first magnet member, a second magnet member, . . . , an M-th magnet member, . . . , and an N-th magnet member. For example, the gap between the second magnet member and the third magnet member may be larger than the gap between the first magnet member and the second magnet member, and the gap between the M-th magnet member and the M+1-th magnet member may be larger than the gap between the M−1-th magnet member and the M-th magnet member. For example, the gap between the first magnet member and the second magnet member may have the smallest value, and the gap between the N−1-th magnet member and the N-th magnet member may have the largest value.

Referring to FIG. 9A, a plurality of magnet members (for example, 150 of FIG. 1, 910, 912, 914, 916, 918, 920 of FIG. 9A) may be arranged such that the gaps between the plurality of magnet members (for example, 150 of FIG. 1, 910, 912, 914, 916, 918, 920 of FIG. 9A) gradually increase. Referring to FIG. 9A, six magnet members 910, 912, 914, 916, 918, 920 may be arranged in the electronic device 100. The six magnet members 150 may be the first magnet member 910, the second magnet member 912, the third magnet member 914, the fourth magnet member 916, the fifth magnet member 918, and the sixth magnet member 920. For example, a gap between the first magnet member 910 and the second magnet member 912 may be a first gap, a gap between the second magnet member 912 and the third magnet member 914 may be a second gap, a gap between the third magnet member 914 and the fourth magnet member 916 may be a third gap, a gap between the fourth magnet member 916 and the fifth magnet member 918 may be a fourth gap, and a gap between the fifth magnet member 918 and the sixth magnet member 920 may be a fifth gap. In this case, for example, the second gap may have a larger value than the first gap, the third gap may have a larger value than the second gap, the fourth gap may have a larger value than the third gap, and the fifth gap may have a larger value than the fourth gap. In this case, referring to FIGS. 9A and 9B, when the second housing 120 rotates relative to the first housing 110, the plurality of magnet members 150 may rotate in a direction to cause the first magnet member 910, the second magnet member 912, the third magnet member 914, and the fourth magnet member 916 to reach the position closest to the hall sensor 130 in sequence. In this case, the time interval between the times at which the greatest magnetic force is detected may gradually increase. For example, the time interval between the time 922 at which the greatest magnetic force is detected by the second magnet member 912 at the hall sensor 130 and the time 924 at which the greatest magnetic force is detected by the third magnet member 914 at the hall sensor 130 may be longer than the time interval between the time 920 at which the greatest magnetic force is detected by the first magnet member 910 at the hall sensor 130 and the time 922 at which the greatest magnetic force is detected by the second magnet member 912 at the hall sensor 130. In one or more embodiments, the electronic device 100 may identify (detect) a direction in which the second housing 120 rotates relative to the first housing 110, based on a gradual increase in the time interval between the times 920, 922, 924 at which the greatest magnetic force is detected through the hall sensor 130.

In one or more embodiments, when the second housing 120 rotates relative to the first housing 110 in a direction opposite to the embodiment described above, the electronic device 100 may identify (detect) the direction in which the second housing 120 rotates relative to the first housing 110, based on a gradual decrease in the time interval between the times 920, 922, 924 at which the greatest magnetic force is detected through the hall sensor 130.

In one or more embodiments, the plurality of magnet members 150 may be irregularly arranged at different intervals without a gradual increase or decrease in the gaps between the plurality of magnet members 150. In this case, the electronic device 100 may identify (detect) an attribute of rotation of the second housing 120 relative to the first housing 110, based on information on the gaps between the plurality of magnet members 150 and a change attribute in the magnetic force detected through the hall sensor 130.

In one or more embodiments, the plurality of magnet members 150 may include a plurality of magnet members 150 which are arranged at different intervals and have different magnetic properties. Even in this case, the electronic device 100 may identify (detect) an attribute of rotation of the second housing 120 relative to the first housing 110, based on information on the magnetic properties of the plurality of magnet members 15, information on the gaps between the plurality of magnet members 150, and a change attribute in the magnetic force detected through the hall sensor 130.

In one or more embodiments, the plurality of magnet members 150 may include a plurality of magnet member sets each including a plurality of magnet members 150. In one or more embodiments, at least some of the plurality of magnet member sets may be a plurality of magnet member sets which are arranged at different intervals. In one or more embodiments, the gaps between the plurality of magnet member sets may all be different. In one or more embodiments, the plurality of magnet member sets may be arranged such that the gaps between the plurality of magnet member sets gradually increase. In one or more embodiments, the plurality of magnet member sets may be arranged such that the gaps between the plurality of magnet member sets gradually decrease.

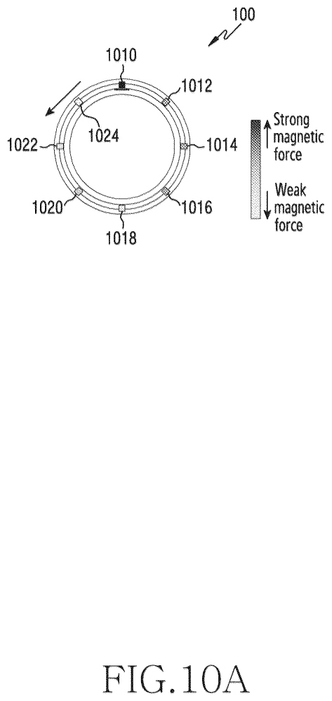

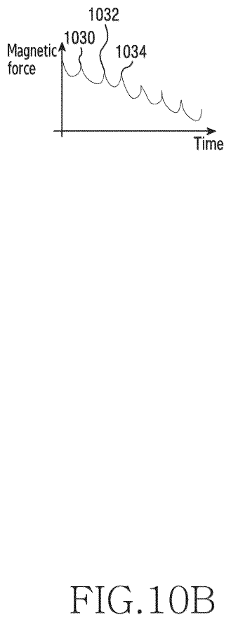

FIGS. 10A and 10B illustrate examples of arrangement of magnet members 150 having different magnetic properties in the electronic device, and a change attribute in the magnetic force according to one or more embodiments.

According to one or more embodiments, at least one magnet member of the plurality of magnet members 150 may have a different magnetic property from that of at least one other magnet member. In one or more embodiments, the magnet members 150 having different magnetic properties may include the magnet members 150 having different magnetic forces acting on the hall sensor 130. For example, the magnet members having different magnetic properties may include the magnet members 150 having different polarities of magnetic forces acting on the hall sensor 130. For example, the magnet members having different magnetic properties may include the magnet members 150 having different magnitudes of magnetic forces acting on the hall sensor 130.

In one or more embodiments, the plurality of magnet members 150 may include a plurality of magnet members 150 which are arranged in order of decreasing the magnitude of the magnetic property. In one or more embodiments, the plurality of magnet members 150 may include a plurality of magnet members 150 which are arranged in order of increasing the magnitude of the magnetic property. For example, the plurality of magnet members 150 may further include a first magnet member, a second magnet member, and a third magnet member, and the first magnet member, the second magnet member, and the third magnet member may be arranged in order of decreasing the magnitude of the magnetic property.

FIG. 10A illustrates an example of the plurality of magnet members 150 which are arranged in the electronic device 100 in order of decreasing the magnitude of the magnetic property, and FIG. 10B is a graph showing a change attribute in the magnetic force while the second housing 120 is rotating relative to the first housing 110 when the magnet members 150 are arranged in order of decreasing the magnitude of the magnetic property as shown in FIG. 10A.

In one or more embodiments, at least some of the plurality of magnet members 150 may be a plurality of magnet members 150 which have magnetic properties of different magnitudes. In one or more embodiments, the magnitudes of the magnetic properties of the plurality of magnet members 150 may all be different. In one or more embodiments, the plurality of magnet members 150 may be arranged such that the magnitude of the magnetic property of each magnet member gradually increases. In one or more embodiments, the plurality of magnet members 150 may be arranged in order of decreasing the magnitude of the magnetic property. For example, when N magnet members 150 are arranged in the electronic device 100, the plurality of magnet members 150 may include a first magnet member, a second magnet member, . . . , an M-th magnet member, . . . , and an N-th magnet member. For example, the magnitude of the magnetic property of the second magnet member may be greater than the magnitude of the magnetic property of the first magnet member, and the magnitude of the magnetic property of the M-th magnet member may be greater than the magnitude of the magnetic property of the M−1-th magnet member. For example, the magnitude of the magnetic property of the first magnet member may have a smallest value out of the N magnet members 150, and the magnitude of the magnetic property of the N-th magnet member may have a greatest value.

Referring to FIG. 10A, a plurality of magnet members (for example, 150 of FIG. 1, 1010, 1012, 1014, 1016, 1018, 1020, 1022, 1024 of FIG. 10A) may be arranged in order of decreasing the magnitude of the magnetic property. Referring to FIG. 10A, 8 magnet members (for example, 150 of FIG. 1, 1010, 1012, 1014, 1016, 1018, 1020, 1022, 1024 of FIG. 10A) may be disposed in the electronic device 100, and the 8 magnet members 150 may be a first magnet member 1010, a second magnet member 1012, a third magnet member 1014, a fourth magnet member 1016, a fifth magnet member 1018, a sixth magnet member 1020, a seventh magnet member 1022, and an eighth magnet member 1024. In this case, the magnitude of the magnetic property of the second magnet member may have a greater value than the magnitude of the magnetic property of the first magnet member, the magnitude of the magnetic property of the third magnet member may have a greater value than the magnitude of the magnetic property of the second magnet member, and the magnitude of the magnetic property of the fourth magnet member may have a greater value than the magnitude of the magnetic property of the third magnet member. In this case, referring to FIGS. 10A and 10B, when the second housing 120 rotates relative to the first housing 110, the plurality of magnet members 150 may rotate in such a direction that the first magnet member 1010, the second magnet member 1012, the third magnet member 1014, and the fourth magnet member 1016 reach the position closest to the hall sensor 130 in sequence. In this case, the maximum value 1030, 1032, 1034 of the magnetic force detected may gradually decrease with time. For example, the maximum value of the magnetic force detected at the time 1032 at which the greatest magnetic force is detected by the second magnet member 1012 at the hall sensor 130 may be greater than the maximum value of the magnetic force detected at the time 1030 at which the greatest magnetic force is detected by the first magnet member 1010 at the hall sensor 130. In one or more embodiments, the electronic device 100 may identify (detect) a direction in which the second housing 120 rotates relative to the first housing 110, based on a gradual increase in the time interval between the times 1030, 1032, 1034 at which the greatest magnetic force is detected through the hall sensor 130.

In one or more embodiments, when the second housing 120 rotates relative to the first housing 110 in a direction opposite to the embodiment described above, the electronic device 100 may identify (detect) a direction in which the second housing 120 rotates relative to the first housing 110, based on a gradual decrease in the maximum value of the magnetic force at the time when the greatest magnetic force is detected through the hall sensor 130.

In one or more embodiments, the plurality of magnet members 150 may be irregularly arranged regardless of the magnitude of the magnetic property without a gradual increase or decrease in the magnitude of the magnetic property of the plurality of magnet members 150. Even in this case, the electronic device 100 may identify (detect) an attribute of rotation of the second housing 120 to the first housing 110, based on information on the magnetic property of the plurality of magnet members 150 and a change attribute in the magnetic force detected through the hall sensor 130.

In one or more embodiments, the plurality of magnet members 150 may include a plurality of magnet members 150 which are arranged at different intervals and have different magnetic properties. Even in this case, the electronic device 100 may identify (detect) an attribute of rotation of the second housing 120 relative to the first housing 110, based on information on the magnetic property of the plurality of magnetic members 150, information on the gaps between the plurality of magnet members 150 and a change attribute in the magnetic force detected through the hall sensor 130.

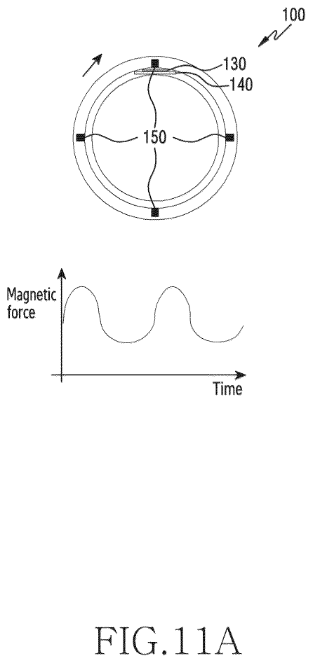

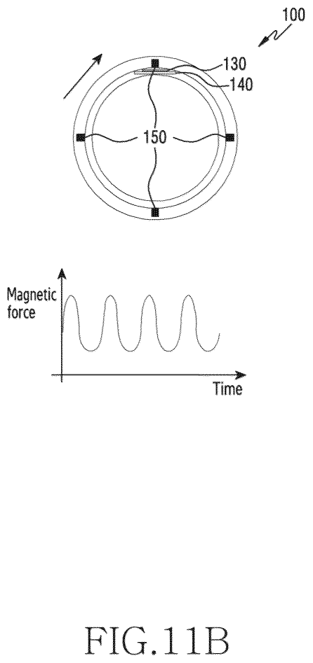

FIGS. 11A and 11B illustrate a change attribute in the magnetic force according to a rotation speed of a housing in the electronic device according to one or more embodiments.

FIGS. 11A and 11B are views for comparing the periods of change in the magnetic force when the speed at which the second housing 120 rotates relative to the first housing 110 is different in the electronic device 100 of the same configuration. For example, FIG. 11A illustrates a case where the second housing 120 rotates relative to the first housing 110 at a relatively fast speed, and FIG. 11B illustrates a case where the second housing 120 rotates relative to the first housing 110 at a relatively slow speed.

According to one or more embodiments, in the electronic device 100 of the same configuration, when the second housing 120 rotates relative to the first housing 110 at a relatively fast speed (FIG. 11A), the period in which the plurality of magnet members 150 reach the position closest to the hall sensor 130 may be shorter than when the second housing 120 rotates relative to the first housing 110 at a relatively slow speed (FIG. 11B). Accordingly, when the second housing 120 rotates relative to the first housing 110 at the relatively fast speed (FIG. 11A), the period in which the magnetic force sensed by the hall sensor 130 has a maximum value may be shorter than when the second housing 120 rotates relative to the first housing 110 at the relatively slow speed (FIG. 11B). For example, when the second housing 120 rotates relative to the first housing 110 at the relatively fast speed (FIG. 11A), the period of change in the magnetic force sensed by the hall sensor 130 may be shorter than when the second housing 120 rotates relative to the first housing 110 at the relatively slow speed (FIG. 11B).

According to one or more embodiments, the electronic device 100 may identify (detect) a speed at which the second housing 120 rotates relative to the first housing 110, based on the period of change in magnetic force detected by the hall sensor 130. For example, the electronic device 100 may identify (detect) that the speed at which the second housing 120 rotates relative to the first housing 110 is relatively high when the period of change in the magnetic force detected via the hall sensor 130 is relatively short. For example, the electronic device 100 may identify (detect) that the speed at which the second housing 120 rotates relative to the first housing 110 is relatively low when the period of change in the magnetic force detected via the hall sensor 130 is relatively long.

According to one or more embodiments, the method by which the magnet members 150 are arranged may include a number of different methods, and is not limited to the above-described embodiments.

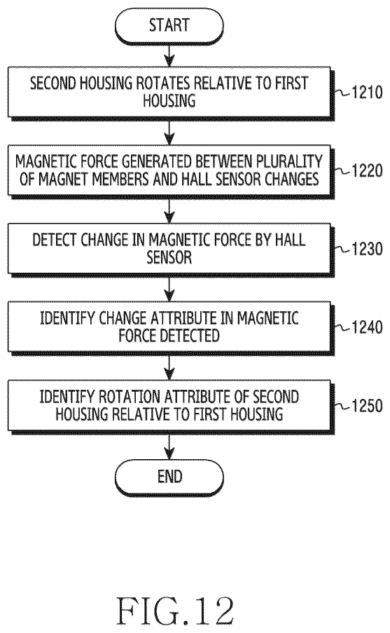

FIG. 12 is a flowchart of a process of identifying an attribute of rotation of the second housing 120 relative to the first housing 110 in the electronic device according to one or more embodiments.

At step 1210, the second housing 120 may rotate relative to the first housing 110.

According to one or more embodiments, the electronic device 100 may include ring-shaped housings. The electronic device 100 according to one or more embodiments may be worn on a user by the ring-shaped housings. According to one or more embodiments, the electronic device 100 may include a plurality of ring-shaped housings, and may be worn on a user by the plurality of ring-shaped housings. The plurality of ring-shaped housings may be coupled (connected) to be rotatable relative to at least one other housing. At least one of the plurality of ring-shaped housings may be rotated relative to at least one other housing under force from the user. In one or more embodiments, at least one of the plurality of ring-shaped housings may be rotated relative to at least one other housing by receiving a rotating force from the user. For example, while the electronic device 100 is worn by the user, at least a part of the plurality of ring-shaped housings included in the electronic device 100 may be rotated relative to at least one other housing by receiving a force from the user. For example, while the electronic device 100 is worn on user's index finger, at least a part of the plurality of ring-shaped housings included in the electronic device 100 may be rotated relative to at least one other housing by receiving a force by user's thumb.

At step 1220, the magnetic force generated between the plurality of magnet members 150 and the hall sensor 130 may change. In one or more embodiments, as the second housing 120 rotates relative to the first housing 110, the magnetic force generated between the plurality of magnet members 150 and the hall sensor 130 may change. For example, when the magnet member reaches a portion closest to the hall sensor 130 due to the rotation of the housing, the magnetic force detected by the hall sensor 103 may have a maximum value or a minimum value. For example, as the gap between the magnet member and the hall sensor 130 changes due to the rotation of the housing, the magnetic force detected by the hall sensor 130 may change. For example, as the distance between the magnet member and the hall sensor 130 continuously changes due to the rotation of the housing, the magnetic force detected by the hall sensor 130 may continuously change.

At step 1230, the electronic device 100 may detect the change in the magnetic force through the hall sensor 130. In one or more embodiments, the hall sensor may detect the existence of a magnetic field, a location of occurrence, and a strength thereof. In one or more embodiments, the hall sensor 130 and the plurality of magnet members 150 may be disposed in different housings. In one or more embodiments, the hall sensor 130 included in the electronic device 100 may detect a change in the magnetic force acting on the hall sensor 130 according to the rotation of the plurality of magnet members 150 included in at least one of the plurality of housings when at least one of the plurality of housings rotates. For example, the hall sensor 130 included in the electronic device 100 may detect a change attribute in the magnetic force acting on the hall sensor 130 by the rotation of the plurality of magnet members 150 included in at least one of the plurality of housings when at least one of the plurality of housings rotates. For example, the electronic device 100 may include a first housing 110 and a second housing 120, and, when the second housing 120 rotates relatives to the first housing 110, the hall sensor 130 included in the first housing 110 may detect a change in the magnetic force acting on the hall sensor 130 and an attribute thereof by the rotation of the plurality of magnet members 150 included in the second housing 120.

At step 1240, the electronic device 100 may identify (detect) the change attribute in the magnetic force detected. For example, the change attribute in the magnetic force may include at least one of a speed of change in the magnetic force, whether the polarity of the magnetic force is changed, an amount of change in the magnetic force, an acceleration of change in the magnetic force, a magnitude of the magnetic force before change of the magnetic force, a magnitude of the magnetic force after change of the magnetic force, a pattern of change in the magnetic force or a graph of change in the magnetic force.

At step 1250, the electronic device 100 may identify (detect) an attribute of rotation of the second housing 120 relative to the first housing 110. According to one or more embodiments, the electronic device 100 may identify (detect) the attribute of rotation of the second housing 120 relative to the first housing 110, based on the change attribute in the magnetic force detected. The attribute of the plurality of ring-shaped housings rotating relative to one another may include information on a speed at which the second housing 120 rotates relative to the first housing 110, a direction in which the second housing 120 rotates relative to the first housing 110, a position of the hall sensor 130 relative to the first housing 110 that is displaced in response to the rotation, a relative position of the second housing 120 to the first housing 110 before rotation, or a relative position of the second housing 120 to the first housing 110 after rotation. However, embodiments are not limited thereto.

FIG. 13 illustrates the electronic device 100 and peripheral devices of the electronic device 100 according to one or more embodiments.

In one or more embodiments, there may exist the electronic device 100, a first external electronic device 1310, a gateway 1320, and at least one second external electronic devices 1333, 1337.

The electronic device 100 may communicate with the first external electronic device 1310 via an antenna (for example, 280 of FIG. 2). For example, the first external electronic device 1310 may be a smartphone.

In one or more embodiments, the first external electronic device 1310 may communicate with the gateway 1320. For example, the gateway 1320 and the first external electronic device 1310 may communicate by using Wi-Fi.

In one or more embodiments, the gateway 1320 may communicate with at least one second external electronic device 1333, 1337. The second external electronic device 1333, 1337 may be, for example, a home appliance (for example, an air conditioner, a television (TV), a refrigerator). For example, the gateway 1320 may transmit a signal to control the second external electronic device 1333, 1337 to the second external electronic device 1333, 1337.

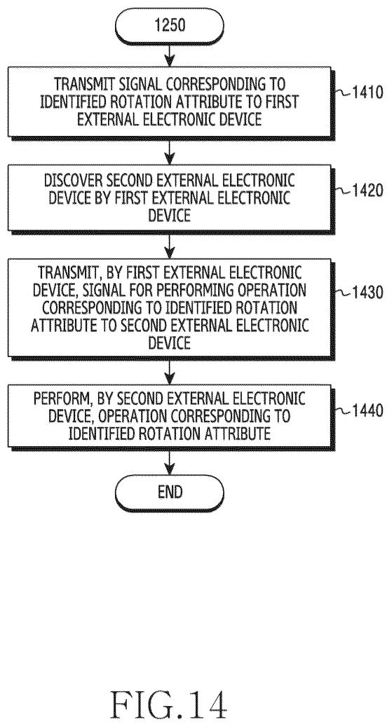

FIG. 14 is a flowchart illustrating a process of the second external electronic device performing an operation corresponding to an identified rotation attribute according to the identified rotation attribute of the electronic device in the electronic device according to one or more embodiments.

At step 1410, the electronic device 100 may transmit a signal corresponding to an identified rotation attribute to the first external electronic device 1310. In one or more embodiments, the electronic device 100 may transmit six-axis information to the first external electronic device 1310 through Bluetooth communication. For example, the attribute of the plurality of ring-shaped housings rotating relative to one another may include information on a speed at which the second housing 120 rotates relative to the first housing 110, a direction in which the second housing 120 rotates relative to the first housing 110, a position of the hall sensor 130 relative to the first housing 110 that is displaced in response to the rotation, a relative position of the second housing 120 to the first housing 110 before rotation, or a relative position of the second housing 120 to the first housing 110 after rotation.

For example, the identified rotation attribute may include information indicating that the speed at which the second housing 120 rotates relative to the first housing 110 is greater than a predetermined value, and the second external electronic device 1333, 1337 may be reproducing a content such as a video or music. In this case, the electronic device 100 may transmit, to the first external electronic device 1310, a signal for increasing the reproduction speed of the content being reproduced by the second external electronic device by a predetermined value or higher.

For example, the identified rotation attribute may include information indicating that the direction in which the second housing 120 rotates relative to the first housing 110 is the first direction, and the second external electronic device 1333, 1337 may be a device that performs a temperature control function. In this case, the electronic device 100 may transmit a signal to increase a target temperature of the second external electronic device 1333, 1337 to the first external electronic device 1310. For example, the identified rotation attribute may include information indicating that the rotation direction is the second direction opposite to the first direction, and the second external electronic device 1333, 1337 may be a device that performs a temperature control function. In this case, the electronic device 100 may transmit a signal to reduce the target temperature of the second external electronic device 1333, 1337 to the first external electronic device.

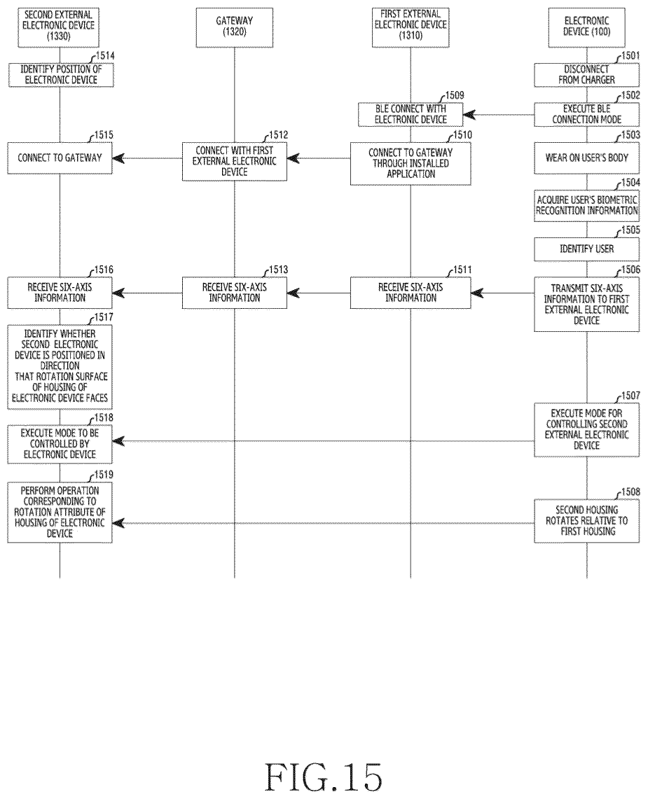

At step 1420, the first external electronic device 1310 may discover the second external electronic device 1333, 1337. According to one or more embodiments, the first external electronic device 1310 may receive six-axis information from the electronic device 100, and may transmit a signal related to the received information to the second external electronic device 1333, 1337. According to one or more embodiments, the first external electronic device 1310 may discover the second external electronic device 1333, 1337 existing in a direction that the rotation axis of the plurality of housings 110, 120 of the electronic device 100 faces, based on the six-axis information received from the electronic device 100 and position information received from the second external electronic device 1333, 1337. In one or more embodiments, the second external electronic device 1333, 1337, which is intended to receive a signal from the first external electronic device 1310, may be discovered through antennas of the electronic device 100 and the second external electronic device 1333, 1337. The process of discovering the second external electronic device 1333, 1337 by the first external electronic device 1310 will be described in detail with reference to FIGS. 15 to 19.

At step 1430, the first external electronic device 1310 may transmit a signal to perform an operation corresponding to the identified rotation attribute to the second external electronic device 1333, 1337.

For example, the identified rotation attribute may include information indicating that the speed at which the second housing 120 rotates relative to the first housing 110 is greater than a predetermined value, and the second external electronic device may be reproducing a content such as a video or music. In this case, the electronic device 100 may transmit, to the first external electronic device 1310, a signal for increasing the reproduction speed of the content being reproduced by the second external electronic device by a predetermined value or higher. The first external electronic device which receives the signal may discover the second external electronic device 1333, 1337 which exists in the direction that the rotation axis of the plurality of housings 110, 120 of the electronic device 100 faces, based on the six-axis information received from the electronic device 100 and location information received from the second external electronic device 1333, 1337. The first external electronic device 1310 may transmit the signal that causes the second external electronic device 1333, 1337 identified by discovering to increase the reproduction speed of the content by a predetermined value or higher to the second external electronic device 1333, 1337.

At step 1440, the second external electronic device 1333, 1337 may perform the operation corresponding to the identified rotation attribute.

For example, the identified rotation attribute may include information indicating that the speed at which the second housing 120 rotates relative to the first housing 110 is greater than a predetermined value, and the second external electronic device may be reproducing a content such as a video or music. In this case, the electronic device 100 may transmit, to the first external electronic device 1310, a signal for increasing the reproduction speed of the content being reproduced by the second external electronic device by a predetermined value or higher. The first external electronic device which receives the signal may discover the second external electronic device 1333, 1337 which exists in the direction that the rotation axis of the plurality of housings 110, 120 of the electronic device 100 faces, based on the six-axis information received from the electronic device 100 and location information received from the second external electronic device 1333, 1337. The first external electronic device 1310 may transmit the signal that causes the second external electronic device 1333, 1337 identified by discovering to increase the reproduction speed of the content by a predetermined value or higher to the second external electronic device 1333, 1337. The second external electronic device 1333, 1337 which receives the signal may control an audio to increase the reproduction speed of the reproduced content by a predetermined value or higher.

FIG. 15 is a flowchart of a process of communicating with the second external electronic device through the first external electronic device by the electronic device according to one or more embodiments.

The second external electronic device 1330 of FIG. 15 may correspond to the second external electronic device 1333, 1337 of FIGS. 13, 17, and 18.

According to one or more embodiments, when the electronic device 100 detects that the electronic device is disconnected from a charger after being connected to the charger (1501), the electronic device may execute a mode for communicating with external electronic devices. For example, the electronic device 100 may execute a BLE connection mode (1502). When the electronic device 100 identifies the first external electronic device 1310, a Bluetooth Low Energy (BLE) connection may be performed between the first external electronic device 1310 and the electronic device 100 (1509). For example, the electronic device 100 and the first external electronic device 1310 may be already paired with each other or may be initially connected with each other.

According to one or more embodiments, the electronic device 100 may detect that the electronic device 100 is worn on user's body through a sensor module (1503). For example, the electronic device 100 may acquire biometric recognition information of the user through the sensor module (1504). For example, the recognized biometric recognition information may be used for identifying the user (1505). For example, the electronic device 100 may store a setting value related to at least one user in a memory (for example, a memory 220 of FIG. 2). In this case, the electronic device 100 may identify (detect) the user by comparing the recognized biometric recognition information and the stored setting value (1505). For example, the electronic device 100 may determine whether to give an authority to control the second external electronic device 1330 to the identified user according to the identified user. For example, the electronic device 100 may determine the second external electronic device 1330 to control according to the identified user. For example, when the identified user is a first user and a setting value corresponding to the first user is related to TV control, the electronic device 100 may determine the second external electronic device 1333, 1337 to identify (detect) as a television (TV).

In one or more embodiments, the electronic device 100 may transmit six-axis information of the electronic device 100 which is acquired through the sensor module to the first external electronic device 1310 (1506). A six-axis sensor may include a gyro sensor or an acceleration sensor, and may acquire the 6-axis information. The first external electronic device 1310 which receives the six-axis information from the electronic device 100 (1511) may transmit the six-axis information to the second external electronic device 1330 through the gateway 1320 (1513). The second external electronic device 1330 may receive the six-axis information of the electronic device 100 (1516), and may identify (detect) whether the second external electronic device 1330 is positioned in a direction that the rotation axis of the plurality of housings 110, 120 of the electronic device 100 faces, based on the received 6-axis information of the electronic device 100 and the location information of the second external electronic device (1517). For example, the second external electronic device 1330 may identify (detect) whether the second external electronic device 1330 is positioned in the direction that the rotation axis of the plurality of housings 110, 120 of the electronic device 100 faces, based on the relative positions among the first external electronic device 1310, the second external electronic device 1330 and the electronic device 100, and the 6-axis information of the electronic device 100 (1517).

In one or more embodiments, when it is identified that the second external electronic device 1330 is positioned in the direction that the rotation axis of the plurality of housings 110, 120 of the electronic device 100 faces, the second external electronic device 1330 may execute a mode to be controlled by the electronic device 100 (1518), and the electronic device 100 may execute a mode for controlling the second external electronic device 1330 (1507). When it is detected that the second housing 120 of the electronic device 100 rotates relative to the first housing 110 in the state in which the mode is executed in each of the electronic device 100 and the second external electronic device 1330 (1508), a related signal may be transmitted to the second external electronic device 1330 through the first external electronic device 1310 and the gateway 1320. The second external electronic device 1330 which receives the signal may perform an operation corresponding to the attribute of rotation of the second housing 120 of the electronic device 100 relative to the first housing 110 (1519).

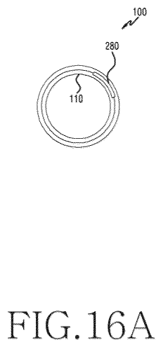

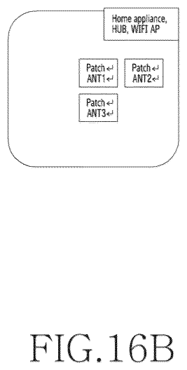

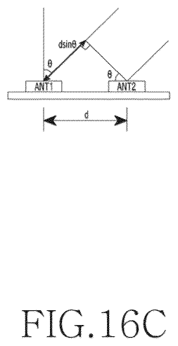

FIGS. 16A, 16B, and 16C are views to explain a method by which the electronic device identifies positions of external electronic devices through an antenna 280 according to one or more embodiments.

FIG. 16A illustrates one or more embodiments in which an antenna 280 is disposed in the electronic device 100. In one or more embodiments, the antenna 280 may be disposed in the housing 110, 120 of the electronic device 100. In one or more embodiments, the antenna 280 may be a part of the housings 110, 120 of the electronic device 100. For example, the antenna 280 may be at least a part of the metal segment portion of the first housing 110 or the second housing 120. For example, the antenna 280 may include a monopole antenna or a dipole antenna.

FIG. 16B illustrates a method by which the antenna 280 is disposed in the first external electronic device 1310, the second external electronic device 1330, 1333, 1337, and the gateway 1320. In one or more embodiments, the antenna 280 may be an antenna array in which a plurality of antennas are connected. For example, the antenna 280 may be an antenna array that is arranged in the horizontal or vertical direction. Referring to FIG. 16B, a first patch antenna, a second patch antenna, and a third patch antenna may be disposed and operate in one device.

FIG. 16C illustrates a method of identifying a position of the first external electronic device 1310 or the second external electronic device 1330, 1333, 1337 through the antenna 280. For example, the antenna 280 may be an antenna that operates in an angle of departure (AoD) method or an angle of arrival (AoA) method. For example, the plurality of antennas included in the antenna array may determine a phase difference of signals by the following Equation 1:

$$Phase Difference = d sin θ \times \frac{2 π}{λ} \qquad Equation 1$$

For example, the plurality of antennas may identify (detect) relative positions of the electronic device 100 and the second external electronic device 1333, 1337, based on the phase difference between signals, which is determined by Equation 1 above.

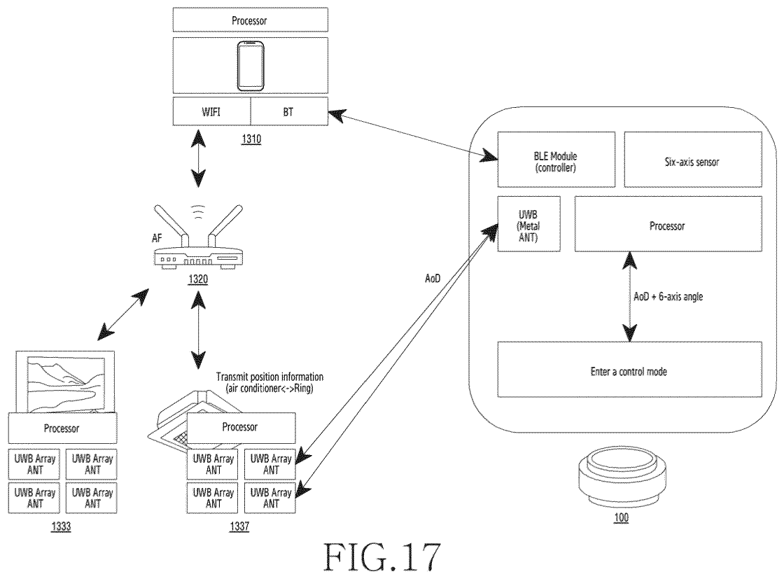

FIG. 17 illustrates a connection structure between the electronic device and external electronic devices, and a position identification method according to one or more embodiments.

In one or more embodiments, there may exist an electronic device 100, a first external electronic device 1310, a gateway 1320, and at least one second external electronic device 1333, 1337. According to one or more embodiments, the electronic device 100 may include a BLE module (for example, a communication module 230 of FIG. 2) for Bluetooth communication, a six-axis sensor (for example, a gyro sensor, an acceleration sensor), an antenna (for example, an antenna 280 of FIG. 2), or a processor (for example, a processor 210 of FIG. 2).

The first external electronic device 1310 may include a processor and may include a communication module for Wi-Fi and Bluetooth communication.

The second external electronic device 1333, 1337 may include a processor, and may include a plurality of antenna arrays for performing BLE communication.

In one or more embodiments, a BLE connection may be performed between the first externa electronic device 1310 and the electronic device 100 (1509). For example, the electronic device 100 and the first external electronic device 1310 may be already paired with each other, or may be initially connected with each other.

In one or more embodiments, the electronic device 100 may transmit six-axis information of the electronic device 100 acquired through a sensor module to the first external electronic device 1310. The six-axis sensor may include a gyro sensor or an acceleration sensor and may acquire six-axis information. The first external electronic device 1310 which receives the six-axis information from the electronic device 100 may transmit the six-axis information to the second external electronic device 1333, 1337 through the gateway 1320.

For example, the antennas of the second external electronic device 1333, 1337 and the electronic device 100 may operate in the AoD method to cause the second external electronic device 1333, 1337 to acquire the six-axis information of the electronic device 100.

The second external electronic device 1333, 1337 may receive the six-axis information of the electronic device 100, and may identify (detect) whether the second external electronic device 1333, 1337 is positioned in a direction that the rotation axis of the plurality of housings 110, 120 of the electronic device 100 faces, based on the six-axis information of the electronic device 100 received, and position information of the second external electronic device 1333, 1337.

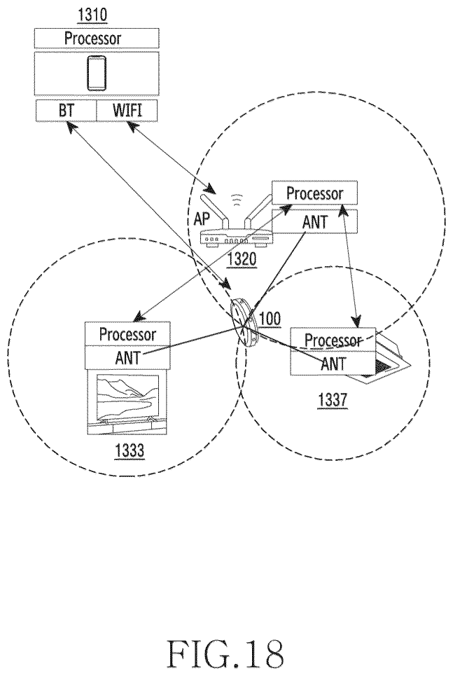

FIG. 18 illustrates a method of identifying positions of the electronic device and external electronic devices according to one or more embodiments.

According to one or more embodiments, the electronic device 100, the first external electronic device 1310 or the second external electronic device 1333, 1337 may include an antenna array that performs short-range wireless communication. For example, the electronic device 100, the first external electronic device 1310, or the second external electronic device 1333, 1337 may perform wireless communication by using ultra-wide band (UWB) wireless communication. In this case, each of the devices may use a wide frequency domain within a low-frequency domain, so that each of the devices may perform wireless communication without mutual interference with an existing communication system even with low spectrum power.

In one or more embodiments, the relative positions of the electronic device 100 and the second external electronic device 1333, 1337 may be identified by using the antennas of the electronic device 100 and the second external electronic device 1333, 1337.

In one or more embodiments, there may be a plurality of second external electronic devices 1333, 1337. In this case, the relative positions of the electronic device 100 and the second external electronic devices 1333, 1337 may be identified by using trilateration between the first external electronic device 1310 and the plurality of second external electronic devices 1333, 1337 or the plurality of second external electronic devices 1333, 1337.

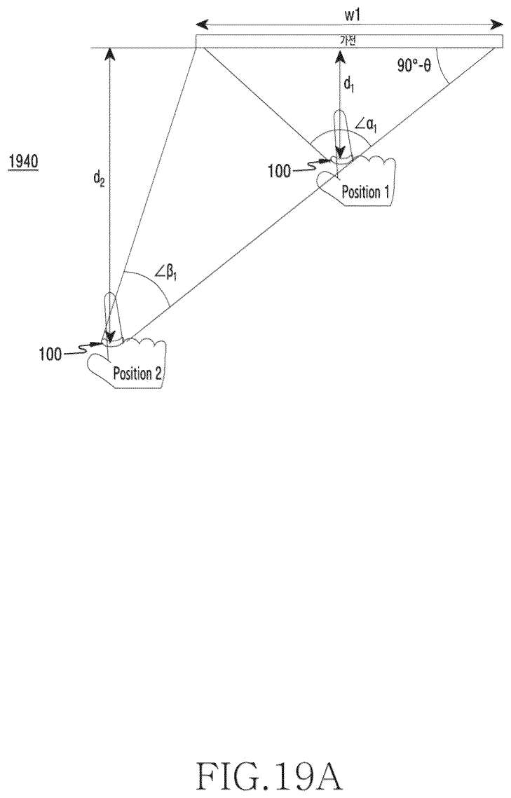

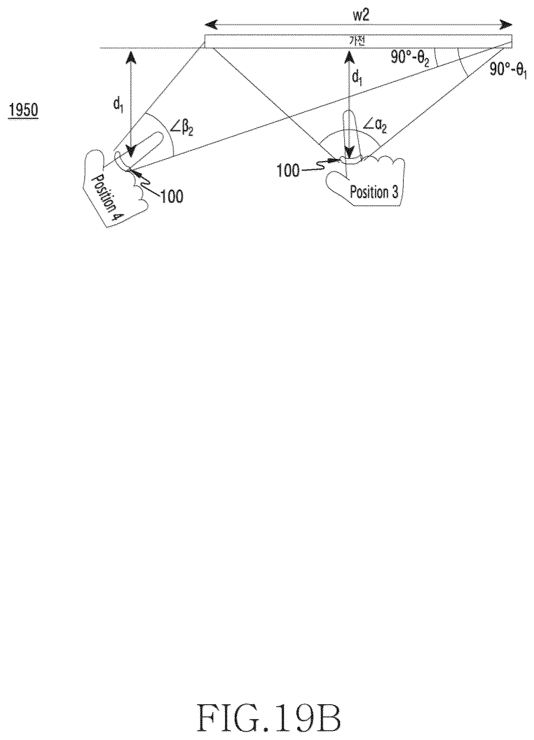

FIGS. 19A and 19B illustrate a range in which the electronic device identifies whether an external electronic device is positioned in a direction that a rotation surface of a housing faces according to one or more embodiments.

FIGS. 19A and 19B are views to explain a method of setting a reference range for identifying whether the second electronic device 1333, 1337 is positioned in a direction that the rotation axis of the housings 110, 120 of the electronic device 100 faces when a distance between the electronic device 100 and the second external electronic device 1333, 1337 is relatively long and when the distance is relatively short.

According to one or more embodiments, the second external electronic device 1333, 1337 being positioned in the direction that the rotation axis of the housings 110, 120 of the electronic device 100 faces may include the direction that the rotation axis of the housings 110, 120 of the electronic device 100 faces facing at least a part of the outer side of the second electronic device 1333, 1337.

Referring to FIGS. 19A and 19B, the electronic device 100 may be positioned at different positions (for example, position 1, position 2), and the electronic device 100 may form an azimuth of the same degree (90°-θ) with reference to the second external electronic device 1333, 1337. Even if the electronic device 100 is positioned at a position forming the azimuth of the same degree with reference to the second external electronic device 1333, 1337, when the distance (for example, d1, d2) between the electronic device 100 and the second external electronic device 1333, 1337 is different, the angle range (for example, α₁, β₁) in which it is identified that the second external electronic device 1333, 1337 is positioned in the direction that the rotation axis of the housings 110, 120 of the electronic device 100 faces may be different. For example, when the distance d2 between the electronic device 100 and the second external electronic device 1333, 1337 is relatively long (for example, when the electronic device 100 is positioned at position 2), the angle range (β₁) in which it is identified that the second external electronic device 1333, 1337 is positioned in the direction that the rotation axis of the housings 110, 120 of the electronic device 100 faces may be narrower than when the distance (d1) between the electronic device 100 and the second external electronic device 1333, 1337 is relatively short (for example, when the electronic device 100 is positioned at position 1) (β₁<α₁).

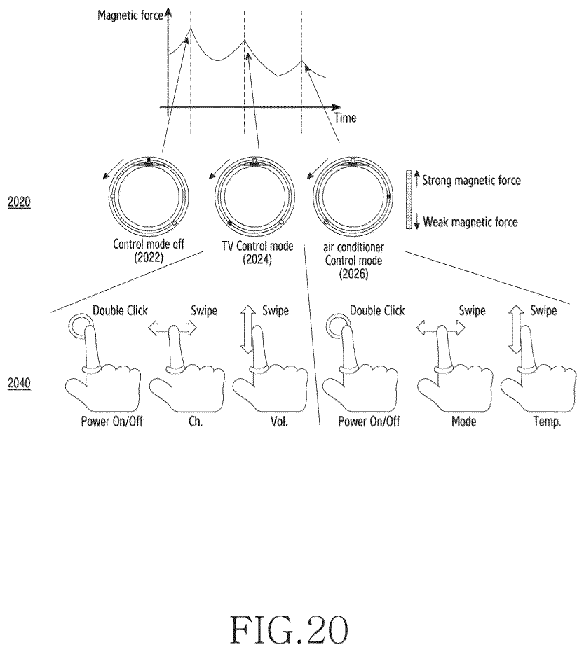

FIG. 20 illustrates an example of controlling an external electronic device that is positioned in a direction that a rotation surface of a housing of the electronic device faces according to one or more embodiments.

Referring to FIG. 20, the electronic device 100 may change the second external electronic device 1333, 1337 to be controlled, or may not control the second external electronic device 1333, 1337 according to a position of the second housing 120 relative to the hall sensor 130 that is displaced in response to the rotation of the second housing 120 relative to the first housing 110. When the plurality of magnet members 150 disposed in the electronic device 100 includes a first magnet member, a second magnet member, and a third magnet member which have different magnetic properties, and the first magnet member is disposed at a position closest to the hall sensor 130 in response to the rotation of the second housing 120 relative to the first housing 110, the electronic device may not control the second external electronic device 1333, 1337. When the second magnet member is disposed at the position closest to the hall sensor 130 in response to the rotation of the second housing 120 relative to the first housing 110, a TV may be determined as the second external electronic device. When the third magnet member is disposed at the position closest to the hall sensor 130 in response to the rotation of the second housing 120 relative to the first housing 110, an air conditioner may be determined as the second external electronic device.

According to one or more embodiments, the electronic device 100 may identify (detect) that the second housing 120 rotates relative to the first housing 110, and may receive input of an additional operation. Referring to FIG. 20, the electronic device 100 may detect that the position of the electronic device 100 is displaced while the electronic device 100 is worn by the user, and, when the trajectory of the detected position displacement corresponds to a set trajectory, the second external electronic device 1333, 1337 may be controlled to perform an operation corresponding to the set trajectory. For example, the electronic device 100 may identify (detect) the position displacement of the electronic device 100 and the trajectory thereof through a gyro sensor or an acceleration sensor.

For example, when the types of second external electronic devices 1333, 1337 are different, the second electronic devices 1333, 1337 may be controlled to perform different operations even if the electronic device 100 is displaced along the same trajectory. For example, the electronic device 100 may determine the TV as the second external electronic device as the second housing 120 rotates relative to the first housing 110, and, when it is identified that the position of the electronic device 100 is displaced toward the first direction, the TV may be controlled to increase the volume of the TV. For example, the electronic device 100 may determine the air conditioner as the second external electronic device as the second housing 120 rotates relative to the first housing 110, and, when it is identified that the position of the electronic device 100 is displaced toward the first direction, the air conditioner may be controlled to change the operation mode of the air conditioner. However, types of additional operations are not limited thereto.

As described above, an electronic device according to one or more embodiments may include a first housing 110 having a ring shape. The electronic device may include a second housing 120 having a ring shape. The first housing and the second housing may be coupled (connected) to be rotatable relative to each other. The electronic device may further include a plurality of magnet members 150. At least some of the plurality of magnet members 150 may be arranged at different intervals in the second housing 120. The electronic device may include a hall sensor 130 disposed in the first housing 110 to detect a magnetic force generated from the plurality of magnet members 150. The electronic device may include at least one processor (for example, a processor 210 of FIG. 2). The electronic device may include a memory (for example, a memory 220 of FIG. 2) configured to store instructions. When executed by the at least one processor (for example, a processor 210 of FIG. 2), the instructions may cause the electronic device to control the hall sensor 130 to identify (detect) a change in the magnetic force that is generated from the plurality of magnet members 150 arranged at different intervals and is detected by the hall sensor as the second housing rotates relative to the first housing by a user input. When being executed by the at least one processor (for example, a memory 210 of FIG. 2), the instructions may cause the electronic device to control the hall sensor 130 to identify (detect) a rotation attribute of the second housing relative to the first housing, based on an attribute of the change in the magnetic force identified.

According to one or more embodiments, the rotation attribute may include at least one of a speed at which the second housing 120 rotates relative to the first housing 110, a direction in which the second housing 120 rotates relative to the first housing 110 or a relative position of the hall sensor to the first housing 110 that is displaced in response to the rotation.

According to one or more embodiments, an electronic device 100 may include a first housing 110 having a ring shape. The electronic device 100 may include a second housing 120 having a ring shape. The first housing 110 and the second housing 120 may be coupled (connected) to be rotatable relative to each other. The electronic device 100 may include a plurality of magnet members 150 including a first magnet member and a second magnet member. A portion of the first magnet member that has a first magnetic property and a portion of the second magnet member that has a second magnetic property may be disposed in the second housing to be adjacent to the first housing. The electronic device 100 may include a sensor 130 disposed in the first housing to detect a magnetic force generated from the plurality of magnet members 150, and may include at least one processor 210 and a memory 220 configured to store instructions. When executed by the at least one processor, the instructions may cause the electronic device to control the sensor 130 to identify (detect) a change in the magnetic force that is generated from the plurality of magnet members 150 and is detected by the sensor 130 as the second housing 120 rotates relative to the first housing 110, and to identify (detect) a rotation attribute of the second housing 120 relative to the first housing 110, based on an attribute of the change in the magnetic force identified. The first magnetic property and the second magnet property may be different from each other.

According to one or more embodiments, the plurality of magnet members 150 may include a first magnet member and a second magnet member. A portion of the first magnet member that has a first magnetic property and a portion of the second magnet member that has a second magnetic property may be disposed in the first housing 110 to be adjacent to the second housing 120.

According to one or more embodiments, a polarity of the first magnetic property may be opposite to a polarity of the second magnetic property.

According to one or more embodiments, a magnitude of the first magnetic property may be different from a magnitude of the second magnetic property.

According to one or more embodiments, the plurality of magnet members 150 may include a plurality of magnet member sets. A first magnet member set of the magnet member sets may include the first magnet member and the second magnet member.

According to one or more embodiments, the plurality of magnet member sets may include the first magnet member set and a second magnet member set.

According to one or more embodiments, a gap between the first magnet member and the second magnet member in the first magnet member set may be shorter than a gap between the first magnet member set and the second magnet member set.

According to one or more embodiments, the plurality of magnet members 150 may further include a third magnet member having a third magnetic property. The first magnet member, the second magnet member, and the third magnet member may be arranged in order of decreasing the magnitude of the magnetic property.

According to one or more embodiments, gaps between the plurality of magnet members 150 may be different.

According to one or more embodiments, the plurality of magnet members 150 may be arranged such that gaps between the plurality of magnet members 150 gradually increase.

According to one or more embodiments, when executed by the at least one processor, the instructions may cause the electronic device 100 to transmit a signal corresponding to the identified rotation attribute to a first external electronic device 1310.

According to one or more embodiments, the signal corresponding to the identified rotation attribute may be used for the first external electronic device 1310 to discover a second external electronic device 1333, 1337 to be controlled by the electronic device 100.

According to one or more embodiments, the second external electronic device 1333, 1338 may be a device that is positioned in a direction that a rotation axis of the first housing 110 or the second housing 120 faces.

According to one or more embodiments, an operation method of an electronic device may include controlling a hall sensor 130 disposed in a first housing 110 to identify (detect) a change in a magnetic force that is generated from a plurality of magnet members 150 and is detected by the hall sensor 130 as the second housing 120 rotates relative to the first housing 110 by a user input. According to one or more embodiments, the operation method of the electronic device may include identifying a rotation attribute of the second housing 120 relative to the first housing 110 based on an attribute of the change in the magnetic force detected. According to one or more embodiments, at least some of the plurality of magnet members 150 may be arranged in the second housing 120 at different intervals.

According to one or more embodiments, in the operation method of the electronic device, the rotation attribute may include at least one of a speed at which the second housing 120 rotates relative to the first housing 110, a direction in which the second housing 120 rotates relative to the first housing 110 or a position of the hall sensor 130 to the first housing 110 that is displaced in response to the rotation.

According to one or more embodiments, the plurality of magnet members 150 may include a first magnet member and a second magnet member. A portion of the first magnet member that has a first magnetic property and a portion of the second magnet member that has a second magnetic property may be disposed in the first housing 110 to be adjacent to the second housing 120.

According to one or more embodiments, a polarity of the first magnetic property may be opposite to a polarity of the second magnetic property.

According to one or more embodiments, a magnitude of the first magnetic property may be different from a magnitude of the second magnetic property.

According to one or more embodiments, the operation method of the electronic device may further include transmitting a signal corresponding to the identified rotation attribute to a first external electronic device 1310. The signal corresponding to the identified rotation attribute may be used for the first external electronic device 1310 to discover a second external electronic device 1333, 1337 to be controlled by the electronic device 100.

According to one or more embodiments, the second external electronic device 1333, 1337 may be a device that is positioned in a direction that a rotation axis of the first housing 110 or the second housing 120 faces.

Hereinafter, a device to which one or more embodiments disclosed According to one or more embodiments are applied or extend will be specified and extended with reference to FIG. 21.

FIG. 21 is a block diagram of an electronic device 2101 in a network environment 2100 according to one or more embodiments.

The electronic device 2101 of FIG. 21 may correspond to the electronic device 100, and may perform operations of the electronic device 100 in FIGS. 1 to 20.

Referring to FIG. 21, the electronic device 2101 in the network environment 2100 may communicate with an electronic device 2102 via a first network 2198 (e.g., a short-range wireless communication network), or at least one of an electronic device 2104 or a server 2108 via a second network 2199 (e.g., a long-range wireless communication network). According to one or more embodiments, the electronic device 2101 may communicate with the electronic device 2104 via the server 2108. According to one or more embodiments, the electronic device 2101 may include a processor 2120, memory 2130, an input module 2150, a sound output module 2155, a display module 2160, an audio module 2170, a sensor module 2176, an interface 2177, a connecting terminal 2178, a haptic module 2179, a camera module 2180, a power management module 2188, a battery 2189, a communication module 2190, a subscriber identification module (SIM) 2196, or an antenna module 2197. In some embodiments, at least one of the components (e.g., the connecting terminal 2178) may be omitted from the electronic device 2101, or one or more other components may be added in the electronic device 2101. In some embodiments, some of the components (e.g., the sensor module 2176, the camera module 2180, or the antenna module 2197) may be implemented as a single component (e.g., the display module 2160).

The processor 2120 may execute, for example, software (e.g., a program 2140) to control at least one other component (e.g., a hardware or software component) of the electronic device 2101 coupled (connected) with the processor 2120, and may perform various data processing or computation. According to one embodiment, as at least part of the data processing or computation, the processor 2120 may store a command or data received from another component (e.g., the sensor module 2176 or the communication module 2190) in volatile memory 2132, process the command or the data stored in the volatile memory 2132, and store resulting data in non-volatile memory 2134. According to one or more embodiments, the processor 2120 may include a main processor 2121 (e.g., a central processing unit (CPU) or an application processor (AP)), or an auxiliary processor 2123 (e.g., a graphics processing unit (GPU), a neural processing unit (NPU), an image signal processor (ISP), a sensor hub processor, or a communication processor (CP)) that is operable independently from, or in conjunction with, the main processor 2121. For example, when the electronic device 2101 includes the main processor 2121 and the auxiliary processor 2123, the auxiliary processor 2123 may be adapted to consume less power than the main processor 2121, or to be specific to a specified function. The auxiliary processor 2123 may be implemented as separate from, or as part of the main processor 2121.

The auxiliary processor 2123 may control at least some of functions or states related to at least one component (e.g., the display module 2160, the sensor module 2176, or the communication module 2190) among the components of the electronic device 2101, instead of the main processor 2121 while the main processor 2121 is in an inactive (e.g., sleep) state, or together with the main processor 2121 while the main processor 2121 is in an active state (e.g., executing an application). According to one or more embodiments, the auxiliary processor 2123 (e.g., an image signal processor or a communication processor) may be implemented as part of another component (e.g., the camera module 2180 or the communication module 2190) functionally related to the auxiliary processor 2123. According to one or more embodiments, the auxiliary processor 2123 (e.g., the neural processing unit) may include a hardware structure specified for artificial intelligence model processing. An artificial intelligence model may be generated by machine learning. Such learning may be performed, e.g., by the electronic device 2101 where the artificial intelligence is performed or via a separate server (e.g., the server 2108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 2130 may store various data used by at least one component (e.g., the processor 2120 or the sensor module 2176) of the electronic device 2101. The various data may include, for example, software (e.g., the program 2140) and input data or output data for a command related thererto. The memory 2130 may include the volatile memory 2132 or the non-volatile memory 2134.

The program 2140 may be stored in the memory 2130 as software, and may include, for example, an operating system (OS) 2142, middleware 2144, or an application 2146.

The input module 2150 may receive a command or data to be used by another component (e.g., the processor 2120) of the electronic device 2101, from the outside (e.g., a user) of the electronic device 2101. The input module 2150 may include, for example, a microphone, a mouse, a keyboard, a key (e.g., a button), or a digital pen (e.g., a stylus pen).

The sound output module 2155 may output sound signals to the outside of the electronic device 2101. The sound output module 2155 may include, for example, a speaker or a receiver. The speaker may be used for general purposes, such as playing multimedia or playing record. The receiver may be used for receiving incoming calls. According to one or more embodiments, the receiver may be implemented as separate from, or as part of the speaker.

The display module 2160 may visually provide information to the outside (e.g., a user) of the electronic device 2101. The display module 2160 may include, for example, a display, a hologram device, or a projector and control circuitry to control a corresponding one of the display, hologram device, and projector. According to one or more embodiments, the display module 2160 may include a touch sensor adapted to detect a touch, or a pressure sensor adapted to measure the intensity of force incurred by the touch.

The audio module 2170 may convert a sound into an electrical signal and vice versa. According to one or more embodiments, the audio module 2170 may obtain the sound via the input module 2150, or output the sound via the sound output module 2155 or a headphone of an external electronic device (e.g., an electronic device 2102) directly (e.g., wiredly) or wirelessly coupled (connected) with the electronic device 2101.

The sensor module 2176 may detect an operational state (e.g., power or temperature) of the electronic device 2101 or an environmental state (e.g., a state of a user) external to the electronic device 2101, and then generate an electrical signal or data value corresponding to the detected state. According to one or more embodiments, the sensor module 2176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2177 may support one or more specified protocols to be used for the electronic device 2101 to be coupled (connected) with the external electronic device (e.g., the electronic device 2102) directly (e.g., wiredly) or wirelessly. According to one or more embodiments, the interface 2177 may include, for example, a high definition multimedia interface (HDMI), a universal serial bus (USB) interface, a secure digital (SD) card interface, or an audio interface.

A connecting terminal 2178 may include a connector via which the electronic device 2101 may be physically connected with the external electronic device (e.g., the electronic device 2102). According to one or more embodiments, the connecting terminal 2178 may include, for example, a HDMI connector, a USB connector, a SD card connector, or an audio connector (e.g., a headphone connector).

The haptic module 2179 may convert an electrical signal into a mechanical stimulus (e.g., a vibration or a movement) or electrical stimulus which may be recognized by a user via his tactile sensation or kinesthetic sensation. According to one or more embodiments, the haptic module 2179 may include, for example, a motor, a piezoelectric element, or an electric stimulator.

The camera module 2180 may capture a still image or moving images. According to one or more embodiments, the camera module 2180 may include one or more lenses, image sensors, image signal processors, or flashes.

The power management module 2188 may manage power supplied to the electronic device 2101. According to one embodiment, the power management module 2188 may be implemented as at least part of, for example, a power management integrated circuit (PMIC).

The battery 2189 may supply power to at least one component of the electronic device 2101. According to one or more embodiments, the battery 2189 may include, for example, a primary cell which is not rechargeable, a secondary cell which is rechargeable, or a fuel cell.

The communication module 2190 may support establishing a direct (e.g., wired) communication channel or a wireless communication channel between the electronic device 2101 and the external electronic device (e.g., the electronic device 2102, the electronic device 2104, or the server 2108) and performing communication via the established communication channel. The communication module 2190 may include one or more communication processors that are operable independently from the processor 2120 (e.g., the application processor (AP)) and supports a direct (e.g., wired) communication or a wireless communication. According to one or more embodiments, the communication module 2190 may include a wireless communication module 2192 (e.g., a cellular communication module, a short-range wireless communication module, or a global navigation satellite system (GNSS) communication module) or a wired communication module 2194 (e.g., a local area network (LAN) communication module or a power line communication (PLC) module). A corresponding one of these communication modules may communicate with the external electronic device via the first network 2198 (e.g., a short-range communication network, such as Bluetooth™, wireless-fidelity (Wi-Fi) direct, or infrared data association (IrDA)) or the second network 2199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 2192 may identify (detect) and authenticate the electronic device 2101 in a communication network, such as the first network 2198 or the second network 2199, using subscriber information (e.g., international mobile subscriber identity (IMSI)) stored in the subscriber identification module 2196.

The wireless communication module 2192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 2192 may support a high-frequency band (e.g., the mmWave band) to achieve, e.g., a high data transmission rate. The wireless communication module 2192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 2192 may support various requirements specified in the electronic device 2101, an external electronic device (e.g., the electronic device 2104), or a network system (e.g., the second network 2199). According to one or more embodiments, the wireless communication module 2192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 2197 may transmit or receive a signal or power to or from the outside (e.g., the external electronic device) of the electronic device 2101. According to one or more embodiments, the antenna module 2197 may include an antenna including a radiating element composed of a conductive material or a conductive pattern formed in or on a substrate (e.g., a printed circuit board (PCB)). According to one or more embodiments, the antenna module 2197 may include a plurality of antennas (e.g., array antennas). In such a case, at least one antenna appropriate for a communication scheme used in the communication network, such as the first network 2198 or the second network 2199, may be selected, for example, by the communication module 2190 (e.g., the wireless communication module 2192) from the plurality of antennas. The signal or the power may then be transmitted or received between the communication module 2190 and the external electronic device via the selected at least one antenna. According to one or more embodiments, another component (e.g., a radio frequency integrated circuit (RFIC)) other than the radiating element may be additionally formed as part of the antenna module 2197.

According to one or more embodiments, the antenna module 2197 may form a mmWave antenna module. According to one or more embodiments, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled (connected) mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to one or more embodiments, commands or data may be transmitted or received between the electronic device 2101 and the external electronic device 2104 via the server 2108 coupled (connected) with the second network 2199. Each of the electronic devices 2102 or 2104 may be a device of a same type as, or a different type, from the electronic device 2101. According to one or more embodiments, all or some of operations to be executed at the electronic device 2101 may be executed at one or more of the external electronic devices 2102, 2104, or 2108. For example, if the electronic device 2101 should perform a function or a service automatically, or in response to a request from a user or another device, the electronic device 2101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 2101. The electronic device 2101 may provide the outcome, with or without further processing of the outcome, as at least part of a reply to the request. To that end, a cloud computing, distributed computing, mobile edge computing (MEC), or client-server computing technology may be used, for example. The electronic device 2101 may provide ultra low-latency services using, e.g., distributed computing or mobile edge computing. In another embodiment, the external electronic device 2104 may include an internet-of-things (IoT) device. The server 2108 may be an intelligent server using machine learning and/or a neural network. According to one or more embodiments, the external electronic device 2104 or the server 2108 may be included in the second network 2199. The electronic device 2101 may be applied to intelligent services (e.g., smart home, smart city, smart car, or healthcare) based on 5G communication technology or IoT-related technology.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to one or more embodiments of the disclosure, the electronic devices are not limited to those described above.

It should be appreciated that one or more embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled (connected) with,” “coupled (connected) to,” “connected with,” or “connected to” another element (e.g., a second element), it means that the element may be coupled (connected) with the other element directly (e.g., wiredly), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an application-specific integrated circuit (ASIC).

One or more embodiments as set forth herein may be implemented as software (e.g., the program 2140) including one or more instructions that are stored in a storage medium (e.g., internal memory 2136 or external memory 2138) that is readable by a machine (e.g., the electronic device 2101). For example, a processor (e.g., the processor 2120) of the machine (e.g., the electronic device 2101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one or more embodiments, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

Methods based on the claims or the embodiments disclosed According to one or more embodiments may be implemented in hardware, software, or a combination of both.

When implemented in software, a computer readable storage medium for storing one or more programs (software modules) may be provided. The one or more programs stored in the computer readable storage medium are configured for execution performed by one or more processors in an electronic device. The one or more programs include instructions for allowing the electronic device to execute the methods based on the claims or the embodiments disclosed According to one or more embodiments.

According to one or more embodiments, the function or the operation that the electronic device performs may be performed by one or more processors executing one or more instructions stored in a memory. The function or operation of the electronic device mentioned According to one or more embodiments may be performed by one processor executing one or more instructions, or may be performed by a combination of a plurality of processors executing one or more instructions. It may be understood that the processor mentioned According to one or more embodiments includes a circuit for performing computation or controlling other components of the electronic device. For example, the one or more processors may include a central processing unit (CPU), a micro-processor unit (MPU), an application processor (AP), a communication processor (CP), a neural processing unit (NPU), a system on chip (SoC), or an integrated circuit (IC) which is configured to execute one or more instructions. The one or more processors may be configured to perform the operation of the electronic device described above.

According to one or more embodiments, the program (the software module or software) may be stored in a random access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs) or other forms of optical storage devices, and a magnetic cassette. Alternatively, the program may be stored in a memory configured in combination of all or some of these storage media. In addition, the memory may be configured by one storage medium or a combination of a plurality of storage media. The one or more instructions may be stored in one storage medium or may be distributed and stored in a plurality of storage media.

Further, the program may be stored in an attachable storage device capable of accessing the electronic device through a communication network such as the Internet, an Intranet, a local area network (LAN), a wide LAN (WLAN), or a storage area network (SAN) or a communication network configured by combining the networks. The storage device may access via an external port to a device which performs the embodiments of the disclosure. In addition, an additional storage device on a communication network may access to a device which performs the embodiments of the disclosure.

In the above-described specific embodiments of the disclosure, elements included According to one or more embodiments are expressed in singular or plural forms according to specific embodiments. However, singular or plural forms are appropriately selected according to presented situations for convenience of explanation, and the disclosure is not limited to a single element or plural elements. An element which is expressed in a plural form may be configured in a singular form or an element which is expressed in a singular form may be configured in plural number.

The term “unit” or “module” used According to one or more embodiments refer to a hardware component such as a processor or a circuit, and/or a software component executed by a hardware component such as a processor.

A “unit”, “module” may be implemented by a program that is stored in a storage medium which may be addressed, and is executed by a processor. For example, a “unit”, “module” may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters.

Specific execution explained According to one or more embodiments is merely an example, and the scope of the disclosure is not limited by any method. For the sake of clarity of the specification, descriptions of related-art electronic components, control systems, software, and other functional aspects of the systems are omitted.

According to one or more embodiments, such phrase as “including at least one of a, b, or c” may refer to “including only a”, “including only b”, “including only c”, “including a combination of two or more (including a and b, including b and c, including a and c, including all of a, b, c)”.

While embodiments have been described with reference to the figures, it will be understood by those of ordinary skill in the art that various changes in form and details may be made therein without departing from the spirit and scope as defined by the following claims and their equivalents.

What is claimed is:

1. An electronic device comprising:
a first housing having a ring shape;
a second housing having a ring shape, the first housing and the second housing being coupled to be rotatable relative to each other;
a plurality of magnet members, at least some of the plurality of magnet members being at different intervals in the second housing;
a sensor in the first housing and configured to detect a magnetic force generated from the plurality of magnet members;
a memory configured to store instructions; and
wherein, when executed by the at least one processor, the instructions cause the electronic device to:
control the sensor to detect a change in the magnetic force that is generated from the plurality of magnet members based on the second housing rotating relative to the first housing; and
detect a rotation attribute of the second housing relative to the first housing based on an attribute of the detected change in the magnetic force.

2. The electronic device of claim 1, wherein the rotation attribute comprises at least one of a speed at which the second housing rotates relative to the first housing, a direction in which the second housing rotates relative to the first housing, and a position of the sensor relative to the first housing.

3. An electronic device comprising:
a first housing having a ring shape;
a second housing having a ring shape, the first housing and the second housing being coupled to be rotatable relative to each other;
a plurality of magnet members comprising a first magnet member and a second magnet member, a portion of the first magnet member that has a first magnetic property and a portion of the second magnet member that has a second magnetic property being in the second housing adjacent to the first housing;
a sensor in the first housing and configured to detect a magnetic force generated from the plurality of magnet members;
a memory configured to store instructions; and
wherein, when executed by the at least one processor, the instructions cause the electronic device to:
control the sensor to detect a change in the magnetic force generated from the plurality of magnet members based on the second housing rotating relative to the first housing; and
detect a rotation attribute of the second housing relative to the first housing based on an attribute of the detected change in the magnetic force,
wherein the first magnetic property and the second magnet property are different from each other.

4. The electronic device of claim 3, wherein a polarity of the first magnetic property is opposite to a polarity of the second magnetic property.

5. The electronic device of claim 3, wherein a magnitude of the first magnetic property is different from a magnitude of the second magnetic property.

6. The electronic device of claim 3, wherein the plurality of magnet members comprise a plurality of magnet member sets, and
wherein a first magnet member set of the plurality of magnet member sets comprises the first magnet member and the second magnet member.

7. The electronic device of claim 6, wherein the plurality of magnet member sets comprise the first magnet member set and a second magnet member set, and
wherein a gap between the first magnet member and the second magnet member in the first magnet member set is less than a gap between the first magnet member set and the second magnet member set.

8. The electronic device of claim 3, wherein the plurality of magnet members further comprise a third magnet member having a third magnetic property, and
wherein a magnitude of a magnetic property of the first magnet member is greater than a magnitude of a magnetic property of the second magnet member, the magnitude of the magnetic property of the second magnet member is greater than a magnitude of a magnetic property of third magnet member.

9. The electronic device of claim 1, wherein gaps between adjacent magnet members of the plurality of magnet members are different.

10. The electronic device of claim 1, wherein gaps between adjacent magnet members of the plurality of magnet members gradually increase.

11. The electronic device of claim 1, wherein the at least one processor is further configured to execute the instructions to transmit a signal corresponding to the identified rotation attribute to a first external electronic device.

12. The electronic device of claim 11, wherein the first external electronic device is configured to detect a second external electronic device to be controlled by the electronic device based on the signal corresponding to the identified rotation attribute.

13. The electronic device of claim 12, wherein the second external electronic device is in a direction that a rotation axis of the first housing or a rotation axis of the second housing faces.

14. A method for detecting a rotation attribute of a housing by an electronic device, the method comprising:
controlling a sensor in a first housing to detect a change in a magnetic force generated from a plurality of magnet members based on the second housing rotating relative to the first housing; and
detecting a rotation attribute of the second housing relative to the first housing based on an attribute of the detected change in the magnetic force,
wherein at least some of the plurality of magnet members are in the second housing at different intervals.

15. The method of claim 14, wherein the rotation attribute comprises at least one of a speed at which the second housing rotates relative to the first housing, a direction in which the second housing rotates relative to the first housing, and a position of the sensor relative to the first housing that is displaced based on the rotation.

16. A method for detecting a rotation attribute of a housing by an electronic device, the method comprising:
controlling a sensor in a first housing to detect a change in a magnetic force generated from a plurality of magnet members based on the second housing rotating relative to the first housing; and
detect a rotation attribute of the second housing relative to the first housing based on an attribute of the detected change in the magnetic force,
wherein the plurality of magnet members comprise a first magnet member and a second magnet member, and
wherein a portion of the first magnet member that has a first magnetic property and a portion of the second magnet member that has a second magnetic property are in the second housing and adjacent to the first housing.

17. The method of claim 16, wherein a polarity of the first magnetic property is opposite to a polarity of the second magnetic property.

18. The method of claim 16, wherein a magnitude of the first magnetic property is different from a magnitude of the second magnetic property.

19. The method of claim 14, further comprising transmitting a signal corresponding to the identified rotation attribute to a first external electronic device; and
detecting, by the first external electronic device, a second external electronic device to be controlled by the electronic device based on the signal corresponding to the identified rotation attribute.

20. The method of claim 19, wherein the second external electronic device is in a direction that a rotation axis of the first housing or a rotation axis of the second housing faces.
